(19) United States
(12) Patent Application Publication
(10) Pub. No.: US 2025/0124105 A1
(43) Pub. Date: Apr. 17, 2025

(54) EFFICIENT TOKEN PRUNING IN TRANSFORMER-BASED NEURAL NETWORKS

(71) Applicant: Intel Corporation, Santa Clara, CA (US)

(72) Inventors: Gopi Krishna Jha, Mysore (IN); Sameh Gobriel, Dublin, CA (US); Nilesh Jain, Portland, OR (US)

(73) Assignee: Intel Corporation, Santa Clara, CA (US)

(21) Appl. No.: 19/002,132

(22) Filed: Dec. 26, 2024

Related U.S. Application Data
(60) Provisional application No. 63/716,292, filed on Nov. 5, 2024.

(51) Int. Cl. G06F 17/16

(52) U.S. Cl. CPC G06F 17/16

(57) ABSTRACT

Key-value (KV) caching accelerates inference in large language models (LLMs) by allowing the attention operation to scale linearly rather than quadratically with the total sequence length. Due to large context lengths in modern LLMs, KV cache size can exceed the model size, which can negatively impact throughput. To address this issue, KVCrush, which stands for KEY-VALUE CACHE SIZE REDUCTION USING SIMILARITY IN HEAD-BEHAVIOR, is implemented. KVCrush involves using binary vectors to represent tokens, where the vector indicates which attention heads attend to the token and which attention heads disregard the token. The binary vectors are used in a hardware-efficient, low-overhead process to produce representatives for unimportant tokens to be pruned, without having to implement k-means clustering techniques.

### PRIORITY

This application is a non-provisional application claiming priority to and/or receiving benefit from U.S. Provisional Application No. 63/716,292, titled, “EFFICIENT TOKEN PRUNING IN TRANSFORMER-BASED NEURAL WORKS” and filed on Nov. 5, 2024. The US Provisional Application is hereby incorporated by reference in its entirety.

### BACKGROUND

Deep neural networks (DNNs) are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary large language model implemented as a transformer-based neural network, according to some embodiments of the disclosure.

FIG. 2 illustrates a serial transformer block, according to some embodiments of the disclosure.

FIG. 3 illustrates a parallel transformer block, according to some embodiments of the disclosure.

FIG. 4 illustrates an attention layer of a transformer block, according to some embodiments of the disclosure.

FIG. 5 illustrates computations in a self-attention layer without key-value (KV) caching, according to some embodiments of the disclosure.

FIG. 6 illustrates computations in a self-attention layer with KV caching, according to some embodiments of the disclosure.

FIG. 7 illustrates a system having distributed workers to execute requests of a transformer-based neural network, according to some embodiments of the disclosure.

FIG. 8 illustrates a KV cache paging scheme, according to some embodiments of the disclosure.

FIG. 9 illustrates a KV cache controller, according to some embodiments of the disclosure.

FIG. 10 illustrates a solution flow for efficient KV cache management, according to some embodiments of the disclosure.

FIG. 11 illustrates calculating attention weights, according to some embodiments of the disclosure.

FIG. 12 illustrates calculating binary vector representations, according to some embodiments of the disclosure.

FIG. 13 illustrates selecting representative tokens, according to some embodiments of the disclosure.

FIG. 14 is a flowchart illustrating a method for KV cache management, according to some embodiments of the disclosure.

FIG. 15 is a flowchart illustrating a method for KV cache management, according to some embodiments of the disclosure.

FIG. 16 is a block diagram of an exemplary computing device, according to some embodiments of the disclosure.

### DETAILED DESCRIPTION

### Overview

The last decade has witnessed a rapid rise in artificial intelligence (AI) based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution operation, matrix multiplication operation, layer normalization operation, batch normalization operation, SoftMax operation, pooling operation, element-wise operation, linear operation, non-linear operation, and so on. While DNNs are effective at analyzing and predicting, they come at a cost of immense computational power. DNNs can consume significant power and runtime during training and during inference.

Transformer-based neural networks or transformer-based models are a type of DNN that can be used to power large language models (LLMs) and computer vision models (referred to in literature as ViTs). Transformer-based neural networks are used in services and applications such as natural language processing, speech processing, conversational AI assistants, image captioning, object detection, video understanding, recommendation systems, bioinformatics, time-series forecasting, reinforcement learning, and generative models to produce text, image, or music. Cloud companies can offer a transformer-based neural network as a hosted service, where the transformer-based neural network can be served by many distributed graphical processing units (GPU) workers, and the hosted service can service many requests for many users.

For some LLMs or other machine learning models, an autoregressive transformer-based neural network is used. The transformer-based neural network can generate one token at a time (e.g., one word at a time) based on an input prompt and the previous sequence of the output's tokens that the transformer-based neural network has generated so far. The process involving performing all the operations in the transformer-based neural network is repeated, token by token, until the transformer-based neural network outputs a termination token. A key-value (KV) cache is introduced to avoid redundant computations when generating tokens one at a time. Specifically, the KV cache allows cached key tensors and value tensors (attention outputs of the operations in the transformer-based neural network) from previous tokens to be reused. A KV cache stores precomputed key tensors and value tensors from the attention calculations and allows them to be reused when generating new tokens.

The cached key tensors and value tensors may include (intermediate) key tensors and value tensors generated in the attention mechanism (e.g., the one or more attention layers in a transformer-based neural network) during the process of producing previous output tokens of a request. Herein, a request refers to an instruction to a transformer-based neural network to generate one or more output tokens based on one or more input tokens. A request may include a request to a transformer-based neural network to generate one or more responses having one or more output tokens in response to an input prompt having one or more input tokens. The generation may involve autoregressive generation of tokens, where, to generate the next token involves using a generated token as part of the input tokens. A request can include or involve one or more tokens. The cached key tensors and value tensors can correspond to the one or more tokens. Using a KV cache to store the cached key tensors and value tensors can significantly reduce computation time and memory usage. The intermediate key tensors and value tensors may include key tensors and value tensors produced across layers and attention heads within a layer during the generation of a token.

Herein, input or output data of deep learning operations, such as the attention outputs or intermediate attention outputs of the attention mechanism in an attention layer, may be arranged in data structures called tensors. A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. The attention mechanism may produce attention outputs, such as key tensors and value tensors that correspond to one or more tokens, which can be cached in the KV cache to avoid redundant computations.

KV caching can accelerate inference in LLMs by allowing the attention operation to scale linearly rather than quadratically with the total sequence length. One important challenge for executing these transformer-based neural networks and serving many requests to the neural networks is the management of KV cache. Due to large context lengths in modern LLMs, KV cache size can exceed the model size, which can negatively impact throughput. Efficient use of the KV cache can reduce the cost of serving individual requests, increase throughput of the hosted service, and increase availability of the hosted service. The challenge can be present where the neural network is being executed with limited memory budget (as in most practical implementations) for the KV cache. Managing the KV cache is not trivial because KV cache size grows linearly with sequence length (each request can be huge), sequence lengths is not known a-priori, and system load (e.g., number of requests to the hosted service) can be unpredictable. In some cases, the KV cache can require several times more memory than the memory used to store the model parameters. Accordingly, deployment of large language models in generating long-context tokens is challenged by high memory demands. This is primarily due to the need to store all previous tokens in the attention module, resulting in a substantial memory footprint of the KV cache.

Some solutions address this challenge by minimizing the memory footprint of the KV cache through techniques such as discarding/skipping low-attention tokens, quantization, and matrix approximation. In one group of approaches, tokens are retained based on the importance of tokens. In other words, important tokens, or a subset of tokens are retained in the KV cache. The importance refers to the importance of the token for the attention mechanism of the transformer-based neural network, or contribution of the token to the attention mechanism. In some cases, the importance can be determined based on attention weights (which indicates the token's contribution), or distance from the current token, etc. Herein, when referring to retention of a token, it means that the KV cache (having cached key tensors and value tensors) corresponding to the token are retained and stored in the KV cache. When referring to discarding/dropping/evicting a token, it means that the KV cache (having cached key tensors and value tensors) corresponding to the token are not stored or kept in the KV cache. Some methods leverage the observation that a small portion of tokens contributes the most value when computing attention scores/weights. Some methods are based on the observation that the importance of tokens decreases exponentially with increasing distance from the current token. Some token-dropping approaches to address this issue focus on eliminating tokens deemed unimportant for the attention algorithm, based on attention weights or distance from the current token, among other factors. However, these approaches often suffer from a lack of accuracy, even with moderate reductions in the number of tokens. In another group of approaches, apart from retaining the important tokens, methods focus on retaining the less important tokens by introducing noise, apply matrix approximation (e.g., approximating large matrices with smaller ones), reducing the precision of data representation (e.g., implement mixed-precision quantization), etc. Some techniques aim to preserve all tokens through various strategies, including matrix approximation, mixed-precision quantization, etc. In some approaches, the methods retain KV caches corresponding to the important tokens, and strategically manage the KV caches corresponding to the less important ones. One method introduces Gumbel noise to retain a diluted version of the unimportant tokens. One method employs mixed-precision quantization to reduce the memory footprint of non-important tokens. One method employs utilizes low-rank matrix approximation. These groups of approaches relate to KV cache compression, which aim to reduce the size of the KV cache. Compression techniques generally can suffer from accuracy loss, if not managed appropriately.

To address one or more of these issues and achieve efficient KV cache compression, an efficient representation for key-value states along with a low-overhead token pruning algorithm are introduced to reduce the size of the KV caches. The techniques described herein may be referred to as KVCrush, which stands for KEY-VALUE CACHE SIZE REDUCTION USING SIMILARITY IN HEAD-BEHAVIOR.

KVCrush offers a hardware-efficient alternative representation of tokens. This scheme leverages attention weight patterns across attention heads to generate a binary vector or binary feature vector for each token. In some embodiments, binary vectors can be calculated based on attention weight matrices computed by the attention heads. Normalized row sums of the attention weight matrices can be calculated for each attention head. The normalized row sums can be binarized using a threshold to obtain the binary vector. The binary vector has values that indicate which attention heads attend to the token and which attention heads disregard it. Additionally, this alternative representation is much smaller than the original key and value tensors or some other floating point feature vector, yet it preserves the semantic information (e.g., to convey token importance and similarities with other tokens) usable for token pruning without significantly impacting accuracy. The teachings can be extended to generate a binary vector or a binary feature vector for each KV cache page having one or more tokens.

KVCrush implements accuracy-aware low-overhead token pruning (or KV cache compression) using the binary vectors. KVCrush leverages the alternative binary representation of tokens and an anchor vector (e.g., representing an anchor point) to bucketize tokens into different buckets (e.g., a bucket may represent a grouping of tokens). The bucketization process (or grouping process) uses low-overhead distance calculations that scale linearly with the number of tokens and does not involve sorting. Different buckets can have corresponding ranges of distances. If a token falls within a particular range of distances corresponding to a bucket, the token is assigned to the bucket. In some embodiments, multiple static/constant anchor vectors (e.g., multiple static/constant anchor points) can be used, which may in some cases, improve the accuracy of the grouping. After bucketization, a representative token can be selected from tokens assigned to the bucket to serve as the proxy or representative for the tokens assigned to the bucket. A representative token can be selected to represent a bucket. The bucketization approach ensures that the overhead introduced by grouping tokens remains minimal (<1%) within the LLM inference flow. The bucketization approach effectively produces proxies or representatives for unimportant tokens, or tokens being pruned, using the buckets in one-shot manner, which is significantly faster than k-means clustering techniques. Representative key tensors and representative value tensors computed for a representative token for a given bucket can be stored in the reduced KV memory footprint and used to approximate the key tensors and value tensors computed for the tokens of the given bucket. This bucketization approach ensures that tokens assigned to different buckets are represented in the reduced KV memory footprint while sufficiently maintaining the inference accuracy of the model.

KVCrush not only outperforms the accuracy of state-of-the-art importance-based token retention schemes by up to 10%, but the approach is also compatible with KV cache paging schemes and mixed quantization schemes.

The techniques described herein offer a KV cache compression scheme to increase LLM inference throughput and reduce latency without sacrificing inference accuracy. The solution can be used for efficient LLM inference on central processing units (CPU), GPUS, and hardware neural network accelerators by reducing the memory footprint of KV caches. The solution also maps efficiently to hardware implementation. The techniques described herein achieve higher accuracy than existing attention importance-based token pruning methods for a given memory budget. This allows companies to scale to a longer context and/or increase the serving capacity, both of which are top priorities for companies offering solutions based on transformer-based neural network models.

For a given memory budget, KVCrush can yield better accuracy than state-of-the-art KV cache compression schemes alone. Also, KVCrush can achieve better compression than other compression techniques. In one experiment, KVCrush can reduce the KV cache size by 4× with less than 1% drop in accuracy with respect to the full cache. In one experiment, KVCrush can achieve state-of-the-art average accuracy with less than 0.5% overhead in total inference latency. Compared to one baseline implementation, KVCrush can achieve significant accuracy gains for state-of-the-art models when evaluated on different use cases such as question answering and summarization.

In some scenarios, running a plain clustering solution for KV cache compression, such as k-means clustering, is infeasible due to very high clustering overhead. In one inference latency study, the results revealed that the approach described herein can reduce average memory access latency by reducing memory footprint and reducing token pruning overhead.

In some experiments using different “anchor points” (e.g., random, mean, alternating ones and zeros), KVCrush was able to outperform baseline accuracy for some models.

Various embodiments described herein may be illustrated in the context of a specific architecture or implementation. It is envisioned that the teachings of the embodiments described herein may apply to other neural networks or models having an attention mechanism where KV caching schemes may be employed to reduce computation. It is also envisioned that the teachings of the embodiments can be applied to distributed computing systems/environments implementing KV caching. It is also envisioned that the teachings of the embodiments can be applied to standalone computing systems implementing KV caching.

### Transformer-Based Neural Networks or Transformer-Based Models

Generative AI Models such as LLMs have taken the computing industry by storm. These models are armed with a gigantic number of parameters, exhibit exceptional state-of-the-art performance across various tasks. Current trends of LLM models are heading to scale of multi-trillion parameter models. According to one estimate, models are growing by 10× every 2 years. Current trajectory makes it practically impossible for smaller and medium players to operate and serve LLMs, and the sheer size of these models (one model requires 325 GB of memory simply to load its model weights) renders traditional optimization techniques like prefetching, dataflow, and caching completely ineffective. Furthermore, LLM during inference presents a tremendous challenge for the compute and memory resources (both bandwidth and capacity) for the platform. Additionally, the strict latency requirement (in the order of 50-100 ms), makes it more challenging to deliver high throughput while maintaining the latency.

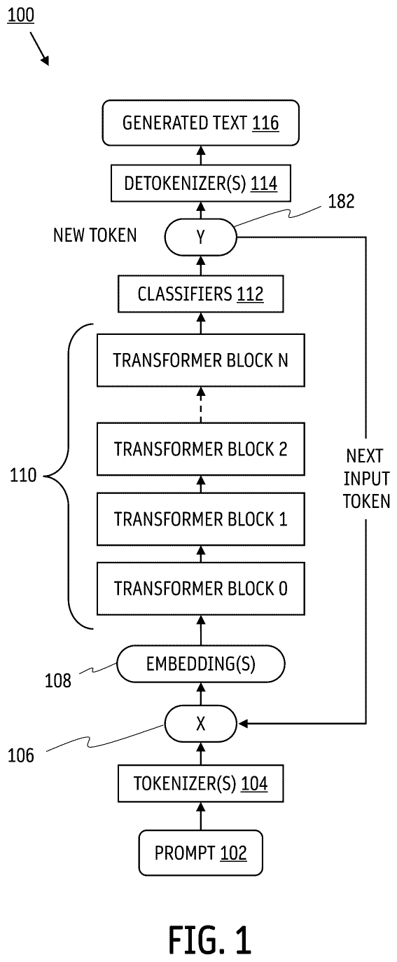

FIG. 1 illustrates an exemplary LLM 100 implemented as a transformer-based neural network, according to some embodiments of the disclosure. LLM 100 may include one or more components: tokenizer(s) 104, a stack of transformer blocks 110 (e.g., shown as transformer block 0, transformer block 1, transformer block 2, . . . . Transformer N), one or more classifiers 112, and detokenizer(s) 114. Tokenizer(s) 104 can break input data (e.g., prompt 102) into tokens. For example, prompt 102 may include text and tokenizer(s) 104 may break prompt 102 into sub-words. One or more tokens, represented as X 106, may be converted into embedding(s) 108, which includes high-dimensional input features for the stack of transformer blocks 110. The stack of transformer blocks 110 can acquire knowledge about the input data.

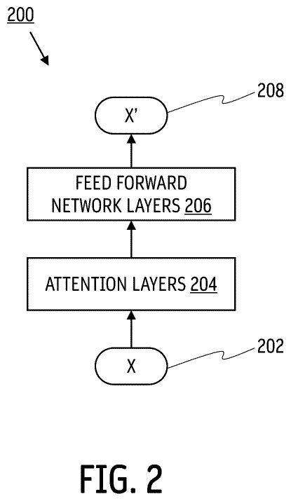

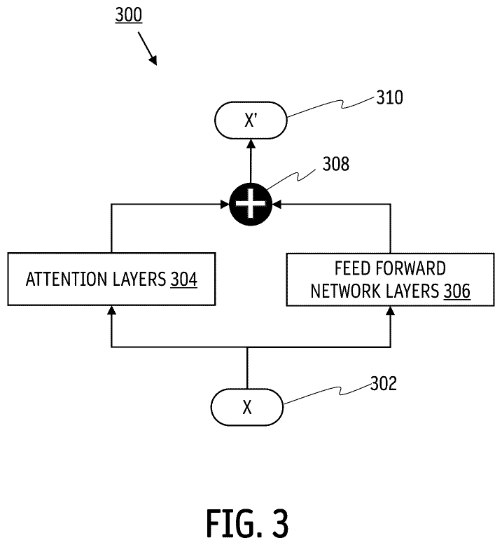

A transformer block in the stack of transformer blocks 110 can include two types of layers equipped with learning parameters: attention layers and feedforward (FFN) layers. One exemplary arrangement of a transformer block is illustrated in FIG. 2. Another exemplary arrangement of a transformer block is illustrated in FIG. 3. Attention layers allow the model to weigh the importance of tokens based on their contextual relevance and to capture their dependencies. Attention layers implement the attention mechanism of a transformer block, which captures contextual information by attending to positions within the sequences. FFN layers provide non-linear transformations to tokens independently.

One or more classifiers 112 can produce predictions or generate tokens based on the learned representations of the stack of transformer blocks 110. The tokens may be used by one or more detokenizer(s) 114 to produce generated text 116.

LLM 100 can serve as a framework for modeling complex relationships in text, images, audio, video, point clouds, graphs, etc. The number of learning parameters can be scaled up using the framework to model even more complex relationships.

LLM 100 is formulated to model sequential text in an autoregressive manner. Each subsequent token, shown as Y 182, is determined by the context of preceding tokens. During the training process of LLM 100, the transformer architecture is tasked to learn to predict the next token, Y 182, through slices of text with known succeeding tokens. Leveraging the abundance of text data available on the Internet, the size of transformers can be scaled up tremendously to hundred-billions of parameters. LLM 100 may be known as autoregressive transformer, causal transformer, decoder-only transformer, and decoding transformer. Subsequent alignment stage can make LLM 100 converse contextually and to human preference. A conversational LLM involving LLM 100 can be referred to as a Generative Pre-trained Transformer (GPT). Aligned LLMs may be known as instruction-tuned, instruction-following, and supervised fine-tuned LLMs.

Autoregressive modeling entails a sequential prediction during its deployment, hence LLM-based applications involve, by and large, text generation, outputting a token after token. The autoregressive nature of the model means engaging the whole model structures for every token prediction. Attributed to the vast number of model parameters (currently reaching scale of billions), the sequence inference is computationally demanding, characterized by an initial compute-intensive first prediction, followed by subsequent token-to-token predictions that are bottlenecked by memory bandwidth. The attention layers computation complexity is quadratic with the sequence length. Such complexity severely bottlenecks the performance especially for longer sequences.

FIG. 2 illustrates serial transformer block 200, according to some embodiments of the disclosure. Serial transformer block 200 includes attention layers 204, and FFN layers 206. An input, X 202, is first processed by attention layers 204, and the output of attention layers 204 is passed to FFN layers 206. FFN layers 206 may produce output, X′ 208. In some cases, serial transformer block 200 may include a skip connection that passes the input, X 202, to be added the output, X′ 210. Serial transformer block 200 may be implemented as one of the transformer blocks of the stack of transformer blocks 110 in FIG. 1.

FIG. 3 illustrates parallel transformer block 300, according to some embodiments of the disclosure. Parallel transformer block 300 includes attention layers 304, and FFN layers 306. An input, X 302, is processed by attention layers 304, and the input, X 302, is processed (in parallel) by FFN layers 306. The output of attention layers 304 and the output of FFN layers 306 are combined at adder 308. Adder 308 may produce a sum of its inputs, e.g., the output of attention layers 304 and the output of FFN layers 306. Adder 308 may produce a weighted sum of its inputs, e.g., the output of attention layers 304 and the output of FFN layers 306. Adder 308 may produce output, X′ 310. In some cases, parallel transformer block 300 may include a skip connection that passes the input, X 302, to be added to the output, X′ 310. Parallel transformer block 300 may be implemented as one of the transformer blocks of the stack of transformer blocks 110 in FIG. 1.

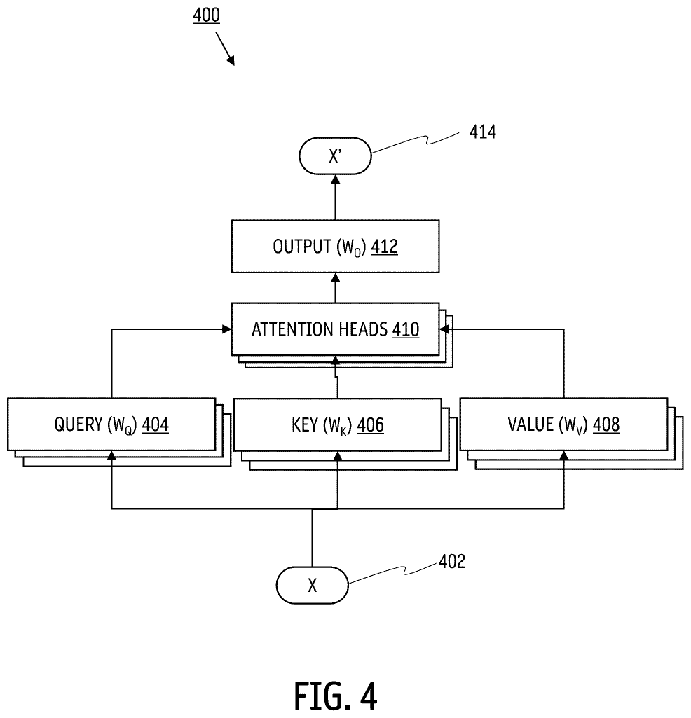

As illustrated in FIG. 1, transformer-based neural network models rely on encoder-decoder stacks with identical layers. As illustrated in FIGS. 2-3, each layer can have two key components: self-attention and feedforward networks. Self-attention allows the model to analyze the entire sequence at once, but a single mechanism might miss nuances. Multi-head attention addresses this by creating multiple independent “heads” that focus on different aspects of word relationships. Multi-head attention mechanism is illustrated in FIG. 4. The outputs from these heads are combined for a richer understanding. Feedforward networks complement self-attention by introducing non-linearity, enabling the model to learn complex patterns. The number of layers stacked in the encoder and decoder (depth) and the number of heads within each layer (width) are hyperparameters. More layers and heads can enhance the model's ability to capture long-range dependencies but increase complexity. Heads and layers of various transformer blocks, work together to give LLMs a nuanced grasp of text data, leading to superior performance natural language processing tasks.

FIG. 4 illustrates attention layer 400 of a transformer block, according to some embodiments of the disclosure. Attention layer 400 may be included as part of a transformer block in the stack of transformer blocks 110 in FIG. 1. As an example, attention layer 400 illustrates a multi-head attention layer having multiple attention head mechanisms. The input, X 402, be converted into queries (Q), keys (K), and values (V). Attention layer 400 includes parallel linear projections 404 of queries using the query weight matrix W_{Q}. Attention layer 400 includes parallel linear projections 406 of keys using the key weight matrix W_{K}. Attention layer 400 includes parallel linear projections 408 of values using the value weight matrix W_{V}. Results of linear projections are provided to parallel attention heads 410. An attention head 410 may apply an attention function using an output from one of the linear projections 404, an output from one of the linear projections 406, and an output from one of the linear projections 408. The attention function can be defined as:

$$Attention ( Q , K , V ) = SoftMax ( \frac{{QK}^{T}}{{d}_{k}} ) V \qquad ( eq . 1 )$$

Q in equation 1 represents an output from one of the linear projections 404. K in equation 1 represents an output from one of the linear projections 406. V in equation 1 represents an output from one of the linear projections 408. dₖ represents a scaling factor. An attention head 410 may compute QK^{T}/dₖ to produce a matrix of raw attention scores based on the queries and keys. An attention head 410 may compute SoftMax

$$( \frac{{QK}^{T}}{{d}_{k}} )$$

V to produce a matrix of attention weights, having a normalized matrix of the raw attention scores. An attention head 410 may compute SoftMax

$$( \frac{{QK}^{T}}{{d}_{k}} )$$

V to produce a final output where the attention weights are weighted by the values to form a final attended representation.

Outputs of parallel attention heads 410 may be concatenated together and passed to linear projection 412 using an output matrix W_{O}. The output of linear projection 412 is the output, X′ 414, of attention layer 400.

A linear projection used in attention layer 400 may include multiplying an input to the linear projection with a learned weight matrix. In some cases, the matrix multiplication is followed by an optional non-linearity, such as an activation function.

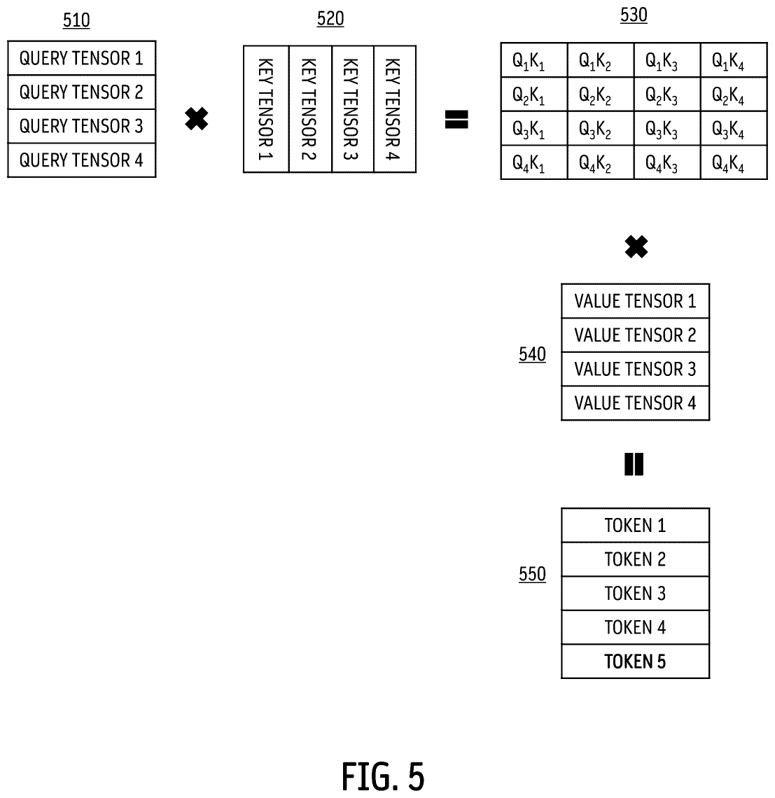

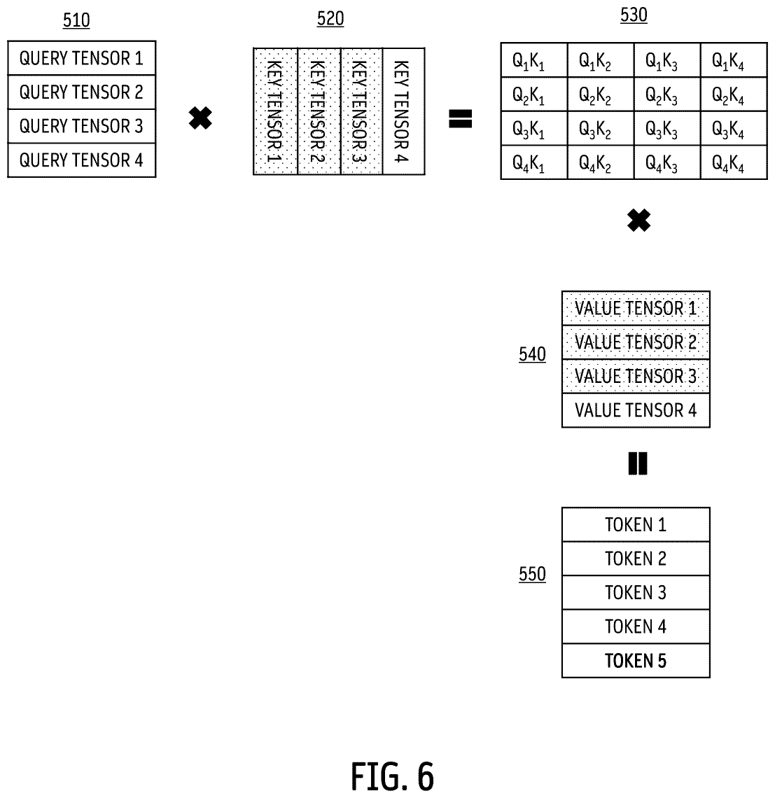

As discussed with FIG. 1, the attention mechanism in an autoregressive transformer-based model is a big bottleneck for performance for long sequences. A KV cache can be provided to store previously computed key tensors and value tensors from the attention mechanism and reuses the cached key tensors and value tensors for generating current tokens, and thus avoids intensive recalculations of the key tensors and value tensors for previous tokens. KV caching became the de-facto optimization of the inference process to accelerate generation throughput for LLMs, allowing the attention operation to scale linearly rather than quadratically in the total sequence length. FIGS. 5 and 6 contrasts computations in an attention layer without KV caching and with KV caching.

### Understanding KV Caching and KV Cache Paging Schemes

FIG. 5 illustrates computations in a self-attention layer without KV caching, according to some embodiments of the disclosure. The self-attention layer may be part of a multi-head self-attention layer. In some embodiments, the self-attention layer is in a decoder of a transformer. In some embodiments, the self-attention layer may be in a transformer block, such as transformer blocks illustrated in FIG. 1. The computations in the self-attention layer may include multiplication of a query matrix 510 and a key matrix 520 (having one or more key tensors), which results in an attention weight matrix 530. The computations in the self-attention layer also includes multiplication of the attention weight matrix 530 and a value matrix 540 (having one or more value tensors), which results in an output matrix 550 encoding new tokens, such as token 5. In some cases, output matrix 550 may include a context-aware attention representation that is weighted by value matrix 540. Output matrix 550 may be produced by the attention layer according to equation 1, using query matrix 510, key matrix 520, and value matrix 540, from which one or more new tokens can be generated. In other embodiments, the computations in the self-attention layer may include other computations, such as computations with a scaling function, SoftMax function, and so on. For the purpose of simplicity and illustration, these computations are not shown in FIG. 5.

Each of the query matrix 510, key matrix 520, and value matrix 540 may include a tensor (e.g., vector) for each of the tokens in the input sequence. For the purpose of illustration and simplicity, the input sequence has four tokens: tokens 1-4. The query matrix 510 may include four query tensors produced based on the four input tokens: query tensors 1-4. The key matrix 520 may include four key tensors: key tensors 1-4. The value matrix 540 may include four value tensors: value tensors 1-4. In the embodiments of FIG. 5, as the decoder does not implement KV caching, computations to produce the key tensors in the key matrix 520 and all the value tensors in the value matrix 540 need to be conducted. Some of the computations have already been conducted in the previous inference phase, e.g., computations to produce the key tensors 1-3 and computations on the value tensors 1-3. The duplication of these computations can be a waste of computational resources, such as power, time, and so on.

FIG. 6 illustrates computations in a self-attention layer with KV caching, according to some embodiments of the disclosure. Different from the embodiments of FIG. 5, the decoder in FIG. 6 implements KV caching. With KV caching, the key tensors and value tensors computed in the previous inference phase(s) (e.g., key tensors and value tensors corresponding to tokens 1-3) are cached in a KV cache and can be reused in the current inference phase. A KV cache stores previously computed key tensors and value tensors computed for one or more tokens in the attention mechanism and reuses them for generating the next attention output or token. In an implementation where distributed GPU workers are executing operations of a neural network, the KV cache can be allocated in GPU memory and contents of the KV cache can be loaded from CPU memory. In an implementation where a processor is executing operations of a neural network, the KV cache can be allocated in one or more memories local to the processor. The execution time scales more gracefully when KV caching is used as the sequence length increases. For instance, the generated intermediate KV tensors corresponding to previous tokens can be stored in a KV cache.

In the current inference phrase illustrated in FIG. 6, the cached key tensors and value tensors can be retrieved from a KV cache. Data that can be retrieved from the KV cache is highlighted with a dotted pattern in FIG. 6. Key tensors 1-3 may be retrieved from the KV cache. Value tensors 1-3 may be retrieved from the KV cache. In the current inference phase, the query matrix 510 can be multiplied with a concatenation of key tensor 4 and cached key tensors 1-3, followed by a SoftMax of the entire raw attention scores. The attention weights produced by performing SoftMax of the raw attention scores can be further multiplied with a concatenation of value tensor 4 and cached value tensors 1-3 to generate new results. After the inference is completed, key tensor 4 can be added to the KV cache. In some cases, the key tensors 1-3 can be updated in the KV cache. Also, value tensor 4 is added to the KV cache. In some cases, the value tensors 1-3 can be updated in the KV cache. This process is repeated per token. KV caching can reduce the number of computations in the self-attention layer. The amount of computation is reduced significantly when cached key tensors and value tensors can be reused to generate the next token. Therefore, computational resources can be saved. The performance and efficiency of the transformer model can be improved through KV caching.

When the KV cache is used, the previously computed key-value tensors are stored in memory (e.g., the KV cache) to avoid repetitive key-value projection computation in the attention mechanism, as illustrated in FIG. 6. The total memory footprint for a KV cache instance can be easily computed using equation 2:

$$Size = 2 \times precision \times {n}_{layers} \times {d}_{model} \times {L}_{sequence} \times B \qquad ( eq . 2 )$$

precision is the number of bytes per value stored (e.g., B for FP32), Players represents the number of layers in the model, d_{model} represents the dimensionality of the embeddings, L_{sequence} is the length of context in tokens, B is the batch size and the factor two is applied because two matrices for keys (K) and values (V) are needed.

As shown in equation 2, the KV cache size scales linearly with the (maximum) sequence length in the input context and the batch size. In practice, the size for the KV cache can be enormous. For example, a 175 billion parameters transformer-based model can consume around 325 GB of memory for storing the parameters. At the same time, at batch size 128 and sequence length 8K, the KV cache can have a size of around 4608 GB of memory, which is several orders of magnitude (12×) larger than the model weights themselves. Since the total sequence length cannot be known ahead of time, the KV cache memory requirements are therefore unknown, and this makes LLM memory management particularly challenging. Typically, the maximum sequence length (usually, 4K, and growing rapidly) is used for memory allocation to host the KV cache which leads to severely fragmented memory and very low batch size, and as a result, a low number of concurrent users for an LLM service is feasible.

The problem of the size of the KV cache is becoming increasingly prominent and is one of the key factors that makes LLM model deployment very costly. It is challenging to reduce KV cache memory footprints in LLMs without accuracy drops. With scaling sequence length becoming a critical demand for many companies, this makes limiting the context sequence inconceivable. The only design knob available for scaling a sizeable LLM deployment according to equation 2 is the batch size (B). Reducing batch size in effect reduces the model throughput, which as a result, severely degrades the total number of requests per second the model can serve.

KV cache paging schemes were introduced to improve memory management and increase serving model throughput. KV cache paging schemes manages attention key tensors and value tensors by dividing them into smaller, more manageable chunks, referred to herein as KV cache pages. The physical KV cache of a GPU worker is partitioned into fixed-sized blocks. The computed key tensors and value tensors can be organized as KV cache pages. A KV cache page can have (computed) key tensors and value tensors for a fixed number of tokens. KV cache pages may be copied into fixed-sized blocks of the physical KV cache of a GPU worker. KV cache paging schemes involve storing a KV cache page in a fixed-sized block in the physical KV cache of the GPU worker. KV cache pages having key tensors and value tensors corresponding to a sequence of tokens can be stored in non-contiguous fixed-sized blocks in the physical KV cache of the GPU worker. The GPU worker can be instructed, by instructions sent by a scheduler, e.g., implemented on a CPU, to retrieve the cached key tensors and value tensors of KV cache pages at the specific blocks in the physical KV cache when performing the attention computations to produce the next token. The GPU worker may be instructed to retrieve data from the KV cache based on the memory address provided by a KV cache manager. KV paging schemes are similar to virtual memory and paging in operating systems. When serving an LLM, a centralized scheduler (e.g., a CPU-based computing system) may manage the KV caches of distributed workers (e.g., GPU workers) and coordinate execution of requests by the distributed workers. Specifically, the centralized scheduler may control where KV cache pages are stored on the physical KV caches of the distributed workers. The centralized scheduler may coordinate swap-in and swap-out of KV cache pages and make cached key tensors and value tensors available to a distributed worker when the distributed worker is instructed to execute a request.

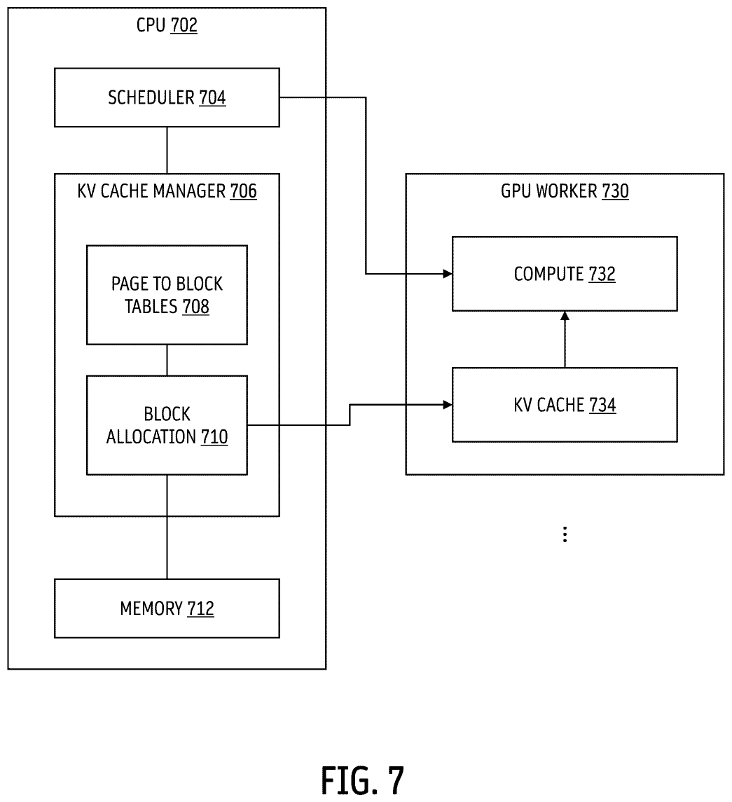

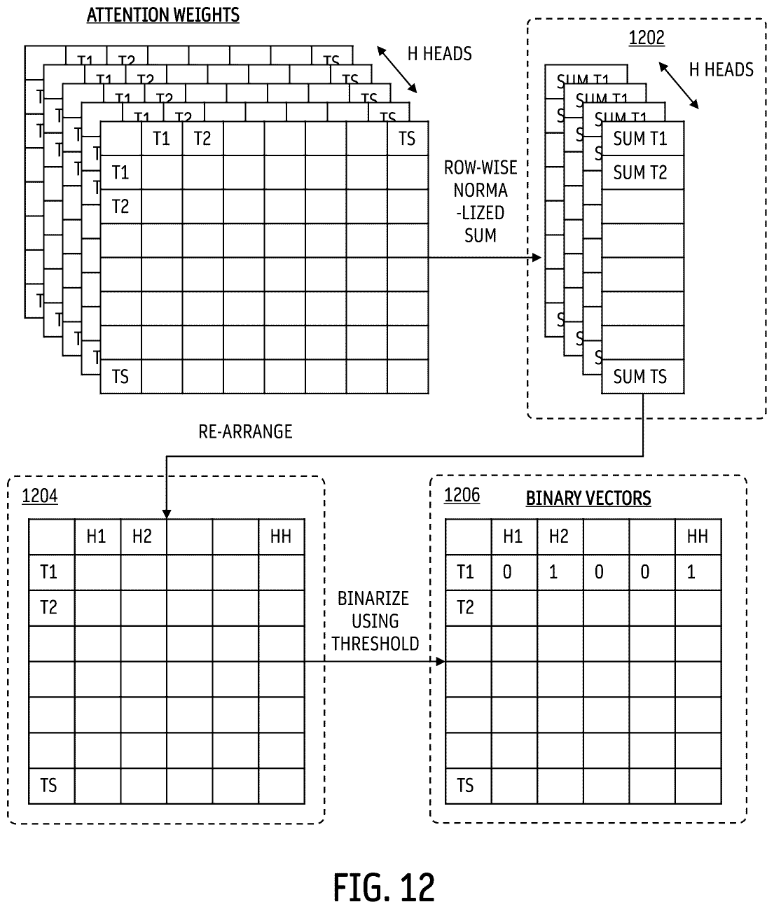

FIG. 7 illustrates a system having distributed workers to execute requests of a transformer-based neural network, according to some embodiments of the disclosure. Distributed workers may be requested by a centralized scheduler to perform one or more operations of a transformer-based neural network. The centralized scheduler may schedule one or more requests to be fulfilled by a worker. The system may include CPU 702, and one or more distributed workers (one instance is shown as GPU worker 730) that are communicably coupled to CPU 702. CPU 702 (e.g., a computing processor, a computing system, a CPU-based computing system, or a computing device 1600 of FIG. 12) may be included to implement functionalities of the centralized scheduler. GPU worker 730 (e.g., a computing processor, a computing system, a GPU-based computing system, a hardware neural network accelerator-based computing system, or a computing device 1600 of FIG. 12) may be included to perform operations of a transformer-based neural network, in response to requests from the centralized scheduler. GPU worker 730 may serve, complete, or fulfill one or more requests.

CPU 702 may include scheduler 704, KV cache manager 706, and memory 712 coupled to or is local to CPU 702. GPU worker 730 may include compute 732 and KV cache 734 coupled to or is local to compute 732.

Scheduler 704 may coordinate the execution of requests by the distributed GPU workers, such as GPU worker 730. The requests may include requests to perform one or more operations of a transformer-based neural network. The coordination performed by scheduler 704 may be based on availability of resources on GPU worker 730 and the operations of the transformer-based neural network to be executed by the distributed GPU workers.

KV cache manager 706 can manage KV caches of the distributed GPU workers (e.g., KV cache 734) in a paged fashion. KV cache manager 706 can manage KV cache 734 through the instructions sent by scheduler 704. The instructions can be included in requests (scheduled by scheduler 704) being sent to and to be executed by compute 732 of GPU worker 730. KV cache manager 706 enables storing key tensors and value tensors for a sequence of tokens in non-contiguous memory space of GPU worker 730. A cache engine (not shown) of GPU worker 730 may allocate a continuous chunk of the memory coupled to or is local to compute 732 to serve as KV cache 734. The cache engine may then divide KV cache 734 into fixed-sized blocks. A block of the physical KV cache 734 may store key tensors and value tensors for a fixed number of tokens (which may be referred to as a KV block size). Similarly, a memory engine (not shown) of CPU 702 may allocate a chunk of memory 712 in CPU 702 for GPU worker 730, or a chunk of memory 712 in memory 712 for a particular request.

KV cache manager 706 may include page to block tables 708. Similar to virtual memory in operating systems, KV cache manager 706 may map a request's logical KV cache pages to blocks in the physical KV cache 734 in page to block tables 708. Page to block tables 708 may include tables that stores the mapping between logical KV cache pages to blocks in KV cache 734 for respective requests. In some embodiments, an entry in the table may record a corresponding location, memory address, or identifier of a physical block in KV cache 734 that corresponds to a logical KV cache page. In some embodiments, the entry may further include the number of filled positions, or availability of space within a block. As a result, contiguous logical KV cache pages corresponding to a sequence of tokens can be mapped to non-contiguous blocks in KV cache 734, but at the same time, compute 732 executing a particular request can access KV cache 734 as though the memory was contiguous. In addition, separating logical KV cache pages and physical blocks allows KV cache manager 706 to grow KV cache 734 without having to reserve a large chunk of memory on GPU worker 730 (for the maximum possible generated sequence length) in advance.

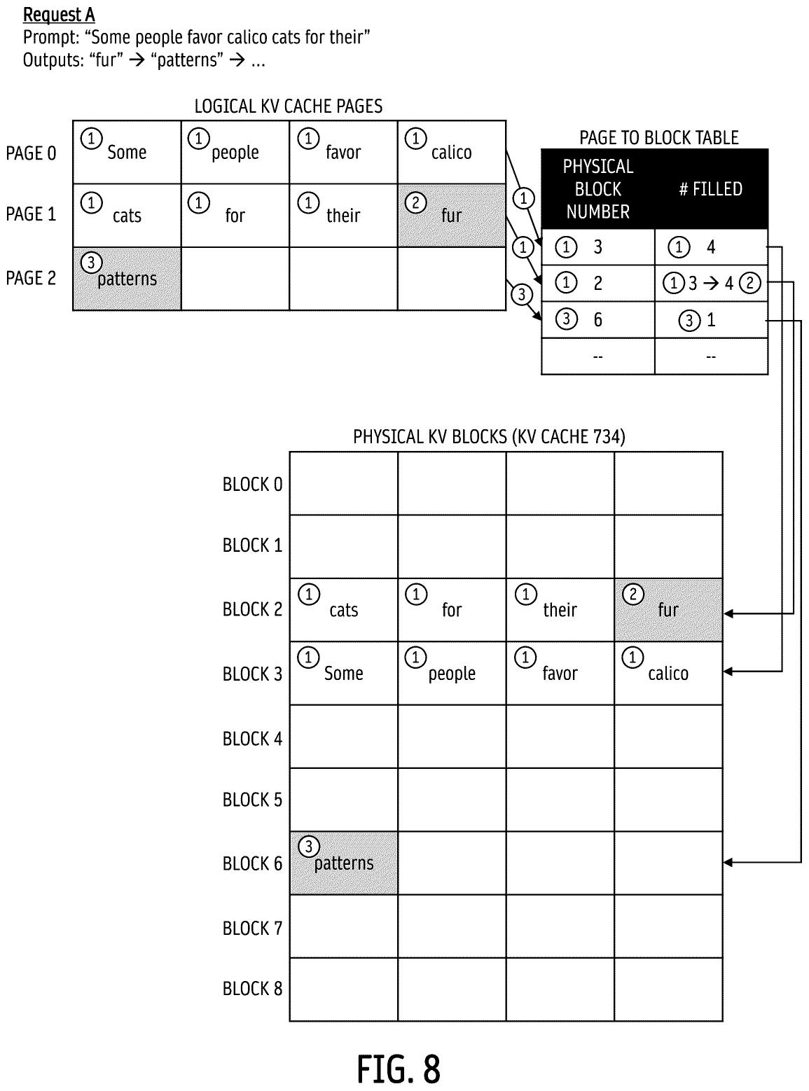

Scheduler 704 may cause one or more KV cache pages to be streamed to GPU worker 730 to swap-in or store the one or more KV cache pages on KV cache 734. Scheduler 704 may include information, such as a page to block table in page to block tables 708 for a particular request, in instructions or messages to GPU worker 730 to allow compute 732 to fetch logical KV cache pages from KV cache 734 at appropriate memory locations/addresses/block identifiers when compute 732 is fulfilling the request. During the attention computation being performed by compute 732, compute 732 may be instructed by instructions sent by scheduler 704 to fetch cached key tensors and value tensors at one or more specified locations/addresses in KV cache 734. A more detailed illustration of the KV cache paging scheme is described with FIG. 8.

As number of requests and output tokens grow, KV cache 734 may run out of physical KV blocks to store the newly generated key tensors and value tensors. Block allocation 710 may be implemented in KV cache manager 706 to perform eviction and swapping. Block allocation 710 may implement an eviction policy to determine whether to evict a particular KV cache page from a physical KV block in KV cache 734. Block allocation 710 may copy one or more evicted KV cache pages (e.g., KV cache pages of a request) to memory 712, such as to a swap space allocated in memory 712 for a particular request. Block allocation 710 may manage or track KV cache pages swapped to memory 712. If KV cache 734 runs out of space, block allocation 710 may select a set of KV cache pages associated with a sequence of tokens of a request to evict and transfer the KV cache pages from KV cache 734 to memory 712. When compute 732 completes other outstanding requests and frees up KV cache pages of the completed requests from KV cache 734, the KV cache pages previously evicted and copied to memory 712 may be swapped-in (copied back to KV cache 734) to allow the request to complete using the KV cache pages in KV cache 734.

FIG. 8 illustrates a KV cache paging scheme, according to some embodiments of the disclosure. A GPU worker (such as GPU worker 730 of FIG. 7) may receive a request to produce one or more output tokens in response to an input prompt: “Some people favor calico cats for their”. The one or more output tokens may include: “fur”→“patterns”→ . . . .

As illustrated in FIG. 8, KV cache 734 of the GPU worker executing one or more requests may store continuous key tensors and value tensors in non-contiguous memory space. A particular request may have one or more logical KV cache pages, and a page to block table that is associated with the particular request. KV cache 734 may be partitioned into fixed-sized blocks, shown as BLOCK 0, BLOCK 1, BLOCK 2, BLOCK 3, BLOCK 4, BLOCK 5, BLOCK 6, BLOCK 7, and BLOCK 8. A fixed-sized block can store key tensors and value tensors for a fixed number of tokens. As shown in the example of FIG. 8, a block in KV cache 734 may store key tensors and value tensors for four tokens. The key tensors and value tensors to be cached for the particular request may be organized as contiguous fixed-sized logical KV cache pages, shown as PAGE 0, PAGE 1, and PAGE 2. A logical KV cache page can correspond to key tensors and value tensors for a fixed number of tokens (e.g., four tokens in the example of FIG. 8). As shown, PAGE 0, PAGE 1, and PAGE 2 are not contiguous on physical KV cache 734.

Different parts of the KV cache paging process are illustrated by numbered circles, 1, 2, and 3.

In part 1 (a prefill operation), the input prompt has seven tokens, and a KV cache manager (KV cache manager 706 of FIG. 7) may map two logical KV cache pages, PAGE 0 and PAGE 1, to physical KV blocks of KV cache 734, BLOCK 3 and BLOCK 2 respectively. The mapping may be stored in a page to block table (e.g., in page to block tables 708 of FIG. 7). The key tensors and value tensors computed for the seven tokens (e.g., “Some people favor calico cats for their”) may be produced by the GPU worker according to an attention mechanism. The key tensors and value tensors computed for the first four tokens (represented as PAGE 0) are stored in BLOCK 3, and key tensors and value tensors computed for the next three tokens (represented as PAGE 1) are stored in BLOCK 2. Note that BLOCK 2 has a remaining slot or free position that isn't used. Page to block table stores a mapping of PAGE 0 to BLOCK 3, and a mapping of PAGE 1 to BLOCK 2. Page to block table may store a number of positions filled for respective logical KV cache pages (e.g., 4 positions filled for PAGE 0, 3 positions filled for PAGE 1).

In part 2 (an autoregressive decoding operation), an output token, “fur”, is generated using the cached key tensors and value tensors stored in BLOCK 3 and BLOCK 2. Since one slot/position remains available in PAGE 1, the key tensors and value tensors produced for the output token, “fur”, is stored in BLOCK 2. The number of positions filled for PAGE 1 in the page to block table may be updated to reflect that all four positions are now filled for PAGE 1.

In part 3 (a further autoregressive decoding operation), a further output token, “patterns”, is generated using the cached key tensors and value tensors stored in BLOCK 3 and BLOCK 2. Since no slot/position are available in PAGE 1 (or PAGE 1 is filled), a new logical KV cache page, PAGE 2, is designated for storing the key tensors and value tensors produced for the output token, “patterns”. A new physical KV block, BLOCK 6, may be allocated in KV cache 734 to store PAGE 2. Page to block table stores a mapping of PAGE 0 to BLOCK 3, a mapping of PAGE 1 to BLOCK 2, and a mapping of PAGE 2 to BLOCK 6. The number of positions filled for PAGE 2 in the page to block table may be set to reflect that one position is filled for PAGE 2.

During the attention computation in the autoregressive decoding operation, the desired cached key tensors and value tensors can be fetched efficiently (from a global shared memory such as memory 712 of FIG. 7) into the GPU worker local memory (such as KV cache 734). The GPU worker can then use the cached tensors in the GPU worker local memory to perform operations of the attention mechanism and fulfill a request. The cached key tensors and value tensors can remain in the GPU worker local memory until the request is completed by the GPU worker or until the cached key tensors and value tensors are to be evicted or swapped-out.

When physical KV blocks in KV cache 734 are dynamically allocated to store logical KV cache pages as more output tokens and their key tensors and value tensors are produced (and new physical KV blocks are allocated only when previous physical KV blocks are full), the KV cache paging scheme limits memory waste and can effectively utilize all the memory. Since each request will not need the maximum context length, this approach allows for sharing of memory across different requests in a batch (hence increasing batch size and throughput), which reduces the wasted memory and memory fragmentation of the KV cache 734.

### Related Work

Techniques to reduce the size of KV caches in transformer-based LLMs can be divided into three categories based on their treatment approach to key-value cache: (1) quantization, (2) sharing, and (3) eviction.

Quantization is the process of reducing the precision of a model's parameters and activations to lower bit-widths to save memory and computational resources. Quantization can be categorized into post-training quantization (PTQ) and quantization-aware training (QAT), with PTQ often preferred for large language models due to its lower resource requirements. Quantizing queries, keys, and values to INT8 enables efficient attention operations, but these methods overlook token importance, potentially degrading generation quality, and lack detailed analysis of KV cache compression's impact on output quality. Some methods employ mixed-precision quantization to allocate different bit-widths to various model components or tensors, enabling more efficient compression. These methods leverage the insight that different parts of a model exhibit varying levels of sensitivity to quantization.

Multi-Query Attention (MQA) and Grouped Query Attention (GQA) are techniques developed to address the memory footprint issues in transformer models by sharing KV caches across heads. MQA reduces memory usage by sharing key and value representations across all attention heads, which enhances memory efficiency and inference speed but may degrade performance and generation quality. GQA extends this concept by grouping query heads to share KVs, balancing memory reduction with better performance retention. However, GQA involves higher training costs and complexity. Both methods offer trade-offs between memory efficiency and model performance, with MQA favoring memory savings and GQA providing a more balanced approach.

Since the rise of LLMs and long-context models, there has been significant interest in methods that prune or evict KV pairs from cache after input processing, aiming to enhance decoding efficiency. By evicting KVs, memory consumption is reduced, facilitating support for larger batch sizes and context windows, while also accelerating decoding by limiting the number of KVs retrieved during attention computation. Different strategies for KV pruning focus on aggregating the attention received by each KV, with low-attention KVs being evicted. Some methods utilize attention-based metrics to determine eviction, e.g., by summing attention weights, or considering the frequency of attention surpassing a threshold. One technique combines these methods with heuristics for special tokens. However, these approaches introduce overhead during prefill due to the global memory requirements of attention aggregation, limiting their overall efficiency, especially for long contexts. To address this, one technique limits the observation window to the final tokens of the input prompt, reducing the complexity from O(L²) to O(L) while using max pooling to retain neighboring KVs. One technique builds on the particular technique by configuring variable eviction rates across layers, with more aggressive pruning in later layers where attention is less evenly distributed. These methods seek to balance prefill and decoding-time performance, optimizing memory use and computation in long-context models.

### KVCrush: Efficient Token Pruning in Transformer-Based Neural Networks Using Alternative Key-Value Representations and a Weak Clustering Algorithm to Select Proxies for KV Cache Compression

KV cache compression methods typically rely on attention weights as the metric of importance. Dropping low-attention weight tokens however changes the token distribution of the input sequence leading to dropped accuracy. KVCrush addresses this problem by selecting representative tokens along with selecting the high-importance tokens.

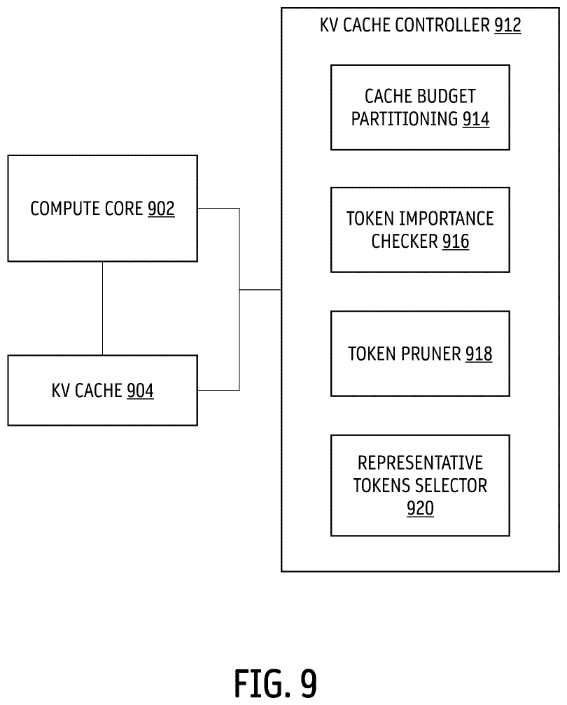

FIG. 9 illustrates KV cache controller 912, according to some embodiments of the disclosure. Compute core 902 may include one or more processors to execute one or more operations of a neural network, such as a transformer-based neural network, or a LLM. A request having one or more tokens can be submitted to the neural network for processing. The one or more operations may include operations of one or more attention heads of the neural network. The operations are described in the context of FIG. 4. Compute core 902 may be communicably coupled to one or more memories to store data usable to perform the one or more operations. The one or more memories may include KV cache 904, which can store cached key tensors and value tensors (e.g., attention outputs of the operations of attention heads in the transformer-based neural network) and allow them to be reused by compute core 902. KV caching is described in the context of FIGS. 6-8.

KV cache controller 912 may be communicably coupled to compute core 902 and/or KV cache 904, to manage KV cache 904. KV cache controller 912 may execute instructions to carry out operations relating to KV cache management. KV cache controller 912 may include one or more of: cache budget partitioning 914, token importance checker 916, token pruner 918, and representative tokens selector 920.

Cache budget partitioning 914 may determine an overall budget for KV cache 904 (e.g., an amount of memory to allocate for storing cached key tensors and value tensors). Cache budget partitioning 914 may determine a budget for storing key tensors and value tensors for important tokens, and a budget for storing representative key tensors and representative value tensors for unimportant tokens.

Token importance checker 916 may evaluate an importance of a token and determine whether a token is important or unimportant. Unimportant tokens are pruned or evicted to compress the KV cache. Token importance checker 916 may determine/evaluate whether a token is important or not. The token may be a part of the request to the neural network, such as transformer-based neural network. Token importance checker 916 may determine that a token is important, based on an importance score or importance of the token. Token importance checker 916 may determine that a token is (otherwise) unimportant, based on an importance score or importance of the token. Token importance checker 916 may determine the importance score or importance of a token based on an attention weight or other metrics associated with the token. The attention mechanism of an attention head of the neural network as carried out by compute core 902, as illustrated in FIG. 4, operates to determine an attention weight matrix based on the query tensors and key tensors corresponding to different tokens. The attention weight matrix may be arranged to have rows corresponding to different query tokens and columns corresponding to different key tokens (or columns corresponding to different query tokens and rows corresponding to different key tokens). Referring to equation 1, the attention weight matrix can include the result of computing QK^{T}/dₖ, SoftMax

$$( \frac{{QK}^{T}}{{d}_{k}} ) ,$$

or a derivation thereof. Token importance checker 916 can leverage the calculated attention weight matrix to determine the attention weight corresponding to a particular token. The attention weight may offer an indication for the particular token's contribution/importance to the attention mechanism, or how much attention the attention mechanism is paying to the particular token. In some cases, the contribution/importance (or an attention weight corresponding to a particular token) may be biased inversely to a distance of the particular token to the current token being processed. Token importance checker 916 may determine whether a token is an important token or an unimportant token based on the attention weight of the token. In some embodiments, determining whether a token is important or unimportant comprises comparing an attention weight corresponding to the token against a threshold. The threshold can be a hyperparameter that is set based on a probability distribution of attention weights. The threshold may be set to classify a certain percentage of tokens as important, and a certain percentage of tokens as unimportant. The token may be determined as important in response to the attention weight crossing or exceeding the threshold. The token may be determined as unimportant in response to the attention weight being less than the threshold.

In response to token importance checker 916 determining that a token is important, one or more key tensors and one or more value tensors calculated by the one or more attention heads corresponding to the important token may be retained by KV cache controller 912. The one or more key tensors and the one or more value tensors may be stored in KV cache 904. The cached key tensor(s) and the cached value tensor(s) can be provided to compute core 902 when compute core 902 is generating one or more further tokens to facilitate reuse.

In response to token importance checker 916 determining that a token is unimportant, or that the token is to be pruned, one or more key tensors and one or more value tensors corresponding to the unimportant token are pruned by token pruner 918. KV cache controller 912 may utilize one or more representative key tensors and one or more representative value tensors selected by representative tokens selector 920 as proxies or representatives instead of the originally computed key tensors and value tensors. The key tensors and value tensors corresponding to the unimportant token may be evicted or dropped by token pruner 918.

Representative tokens selector 920 may implement an algorithm to select representative token using a bucketization strategy to represent a bucket or group of tokens. Representative tokens selector 920 may calculate, based on one or more attention weight matrices computed by one or more attention heads of a neural network, one or more binary vectors representing one or more tokens of a request to the neural network. Representative tokens selector 920 may calculate a binary vector per token, or per page of tokens. Representative tokens selector 920 may assign the one or more tokens to one or more buckets based on one or more distances of the one or more binary vectors to an anchor vector. Representative tokens selector 920 may select a representative token from one or more tokens assigned to a bucket of the one or more buckets.

Token pruner 918 may, based on the results of representative tokens selector 920, store, in KV cache 904, a representative key tensor and a representative value tensor calculated for the representative token by the one or more attention heads of the neural network. When token importance checker 916 determines that a token in the one or more tokens is to be pruned based on an importance of the token and token pruner 918 determines that the token is assigned to the bucket, token pruner 918 can provide, from KV cache 904, the representative key tensor and the representative value tensor to compute core 902 (e.g., computing logic) that is executing one or more operations of the one or more attention heads. The representative key tensor and the representative value tensor approximate a key tensor and a value tensor calculated by an attention head of the one or more attention heads for the token. Token pruner 918 may prune or evict non-representative tokens, or key tensors and value tensors computed for non-representative tokens.

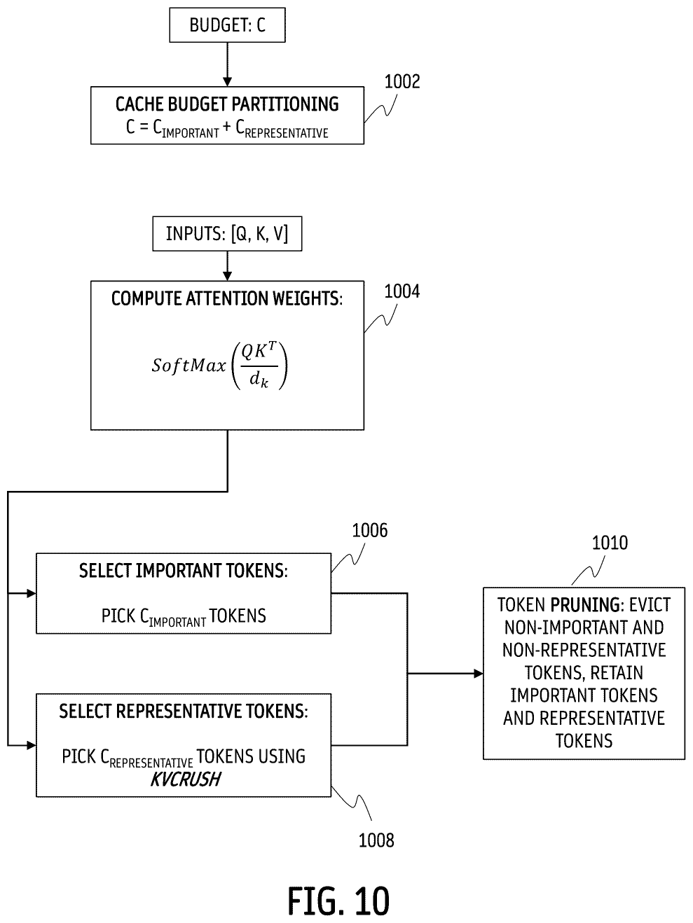

FIG. 10 illustrates a solution flow for efficient KV cache management, according to some embodiments of the disclosure. A KV cache manager, e.g., KV cache controller 912 of FIG. 9 can implement one or more parts of the solution flow illustrated in FIG. 10, to manage a KV cache, e.g., KV cache 904 of FIG. 9.

A cache budget C may include a number of tokens for which the KV cache corresponding to the tokens can be stored in the KV cache. For example, a cache budget C may include 2048 tokens, meaning that the KV caches corresponding to 2048 tokens can be stored in the KV cache, or that the capacity of the KV cache can accommodate 2048 tokens. In 1002, cache budget partitioning can split the cache budget C into two parts:

$$C = {C}_{IMPORTANT} + {C}_{REPRESENTATIVE} \qquad ( eq . 3 )$$

C_{IMPORTANT} can represent the number of important tokens to retain in the KV cache. C_{REPRESENTATIVE} can represent the number of representatives/proxies to store in the KV cache to represent the cache key tensors and value tensors of the unimportant tokens.

In 1004, for given inputs Q, K, and V, attention weights can be computed, e.g., by calculating SoftMax

$$( \frac{{QK}^{T}}{{d}_{k}} ) .$$

Attention weights may be arranged as attention weight matrices.

In 1006, important tokens can selected (e.g., C_{IMPORTANT} number of tokens) using one or more techniques (e.g., implementing a technique described with token importance checker 916 of FIG. 9).

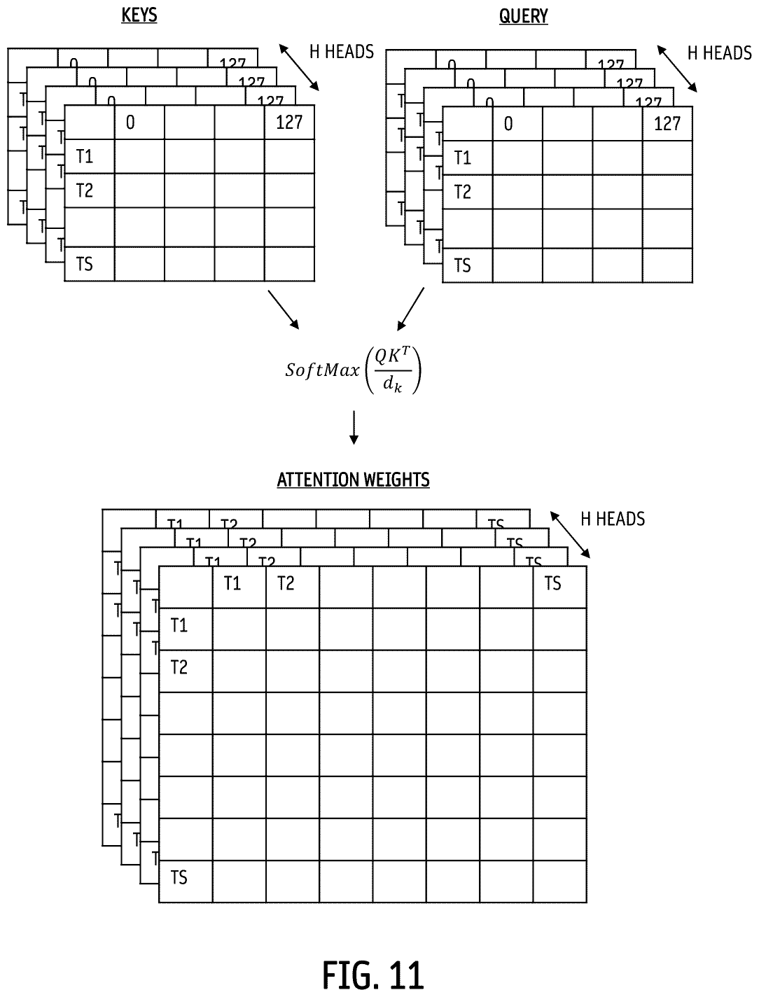

In 1008, for the unimportant tokens, a C_{REPRESENTATIVE} number of representative tokens or proxies can be determined using the KVCrush technique, which is further illustrated by FIGS. 11-13. C_{REPRESENTATIVE} number of representative tokens are retained in the KV cache.

In 1010, token pruning to compress the KV cache is implemented. Non-important and non-representative tokens are not retained in the KV cache and may be evicted from the KV cache. Important tokens are retained in the KV cache. Representative tokens are stored in the KV cache.

Referring back to FIG. 9, cache budget partitioning 914 may implement 1002 illustrated in FIG. 10. Token importance checker 916 may implement 1006 illustrated in FIG. 10. Token pruner 918 may implement 1010 illustrated in FIG. 10. Representative tokens selector 920 may implement 1008 in FIG. 10.

One objective of KVCrush is to replace the large floating point feature vector (of size embedding length) with a compact binary feature vector (of size equal to the number of attention heads, or number of attention heads×page size). The binary vector or binary feature vector advantageously preserves sufficient semantic information to differentiate tokens for efficient grouping and eviction. Based on the insight that distinct attention heads exhibit unique structural patterns associated with different attention heads of the neural network, KVCrush builds a binary vector that can concisely and efficiently represent or identify the attention weight patterns for a token or a page of tokens. Consequently, each token is represented by a concise binary vector derived from the attention weights of the respective heads.

The binary vectors or binary feature vectors are a hardware-efficient alternative representation of tokens. Instead of using a large floating feature vector (of size embedding length), KVCrush uses a small binary feature vector (of size number of attention heads, or number of attention heads×page size if KV cache paging is used) that retains enough semantic information to distinguish one token from the other for the purpose of efficient token pruning. One insight is that different attention heads at different layers or different attention heads in the same layer for a multi-head attention layer can often exhibit distinct structural patterns. Different attention heads usually have different structures. Within a given layer, each attention head focuses on specific types of tokens and ignores the other types of tokens. Leveraging this insight to identify the attention weight patterns for different tokens or pages of tokens, KVCrush determines a hardware-efficient representation of each token, or each page of tokens using a (short) binary vector based on individual head attention weights. Several operations can be applied by representative tokens selector 920 of FIG. 9 to produce the binary vectors. The operations are illustrated in FIGS. 11-12. Specifically, FIGS. 11-12 illustrate a scenario where S tokens (represented as T0, T1, . . . TS) may be processed by H attention heads in the transformer-based neural network.

FIG. 11 illustrates calculating attention weights, according to some embodiments of the disclosure. Each attention head computes an attention weight matrix using the query matrix and key matrix. The attention operator of an attention head (implementing the calculations shown herein as equation 1) may be applied to the “KEYS” and “QUERIES” as shown to produce “ATTENTION WEIGHTS” as shown. Note that the attention weight matrix computation is already done by the neural network during inference. Therefore, the attention weight matrix is available without re-computation.

FIG. 12 illustrates calculating binary vector representations, according to some embodiments of the disclosure. The attention weight matrices are calculated or computed by H attention heads as illustrated in FIG. 11. A normalized row sum of an attention weight matrix of the one or more attention weight matrices can be calculated. The normalized row sum can be calculated for each row of each attention weight matrix, for each token of each attention weight matrix. The row-wise normalized sums can represent token-wise normalized values of a given attention weight matrix calculated by an attention head. The normalized row sums are calculated for each attention weight matrices produced by the H attention heads. The result includes H sets of row-wise normalized sums for S tokens, or H vectors of length S having the normalized row sums, depicted as 1202. Herein, the normalized row sums transform an attention weight matrix by scaling each row's sum of attention weights so that the row sums add up to exactly 1. This process involves first calculating the row sum of all attention weights in a given row, then dividing each row sum by the total sum all row sums (or the total sum of all attention weights). For a given attention weight matrix, the result of calculating the normalized row sums is an S×1 column vector where each element of the vector represents a normalized proportion of each row's sum relative to the total sum of the attention weight matrix.

When the normalized row sums are calculated for each of the H attention weight matrices, the H number of S×1 column vectors can be re-arranged as a matrix of size S×H, depicted as 1204.

The normalized row sum can be binarized using a threshold to produce S binary vectors, or a matrix of size S×H, depicted as 1206. The binary vectors are also referred to herein as binary feature vectors representing the tokens. Normalized row sums of the matrix depicted as 1204 can be binarized using the threshold. A binary vector of the S binary vectors can include a binary value for each attention head of the one or more attention heads, or H binary values corresponding to the H attention heads. The binary value is a selection bit indicating whether a given attention head attends to a particular token or disregards the particular token.

In some embodiments, a threshold per attention head (or column of the matrix depicted as 1204) can be applied to the row sums of the column to produce the binary value, or the selection bit. Applying the threshold can select or reject/discard the token, using zero or 0 to represent rejection by a particular attention head and one or 1 to represent selection by the particular attention head. For example, a threshold representing the 50th percentile (or median) of the row sums of the column can be used. In another example, a threshold at a different percentile of the row sums of the column can be used. In yet another example, a threshold at a mean of the row sums of the column can be used. In yet another example, a fixed value for the threshold predetermined empirically can be used. In yet another example, the value for the threshold may be determined to optimize for one or more metrics, such as accuracy of representative tokens. Using the threshold, the selection bits for the attention heads for a given token be determined. The selection bits can be collated to form a binary vector or binary feature vector for a given token. For example, for H attention heads, each token is represented by an 8-bit binary vector (instead of, e.g., a 128 length FP16 vector of attention weights).

In the implementations where the binary vectors represent pages of tokens (as opposed to individual tokens), each binary vector may have a length of H×page size (where H is the number of attention heads in the transformer-based neural network and page size is the number of tokens for each KV cache page). There may be P binary vectors, where P would be equal to the number of pages. The selection bits for the tokens of a page are concatenated together to form the binary vector in an interleaved manner (e.g., round-robin fashion) according to the tokens of the page. For example, suppose a page P0 includes two tokens (page size=2), T0 and T1, the binary vector for token TO corresponding to H=4 heads is [0, 0, 0, 0], and the binary vector for token T1 is [1, 1, 1, 1]. Then, the binary vector for page P0 is [0, 1, 0, 1, 0, 1, 0, 1, 0, 1].

Using binary vectors as an alternative representation of the tokens, it is possible to implement a low-overhead token pruning algorithm, since mathematical calculations with binary vectors are far more efficient than mathematical calculations of floating point valued vectors. In addition, the low-overhead token pruning algorithm does not involve clustering, rather, the low-overhead token pruning algorithm performs bucketization or grouping. While clustering-based techniques can produce accurate centroids of clusters for use as proxies, but those techniques can suffer from high-overhead due to clustering algorithms being computationally intensive. In some studies, it has been shown that a significant portion of compute cycles are spent performing clustering when implementing token pruning.

To prune redundant or non-representative tokens and find representatives for the pruned tokens efficiently, a grouping or bucketizing technique can be implemented. The grouping or bucketizing technique can be based on a low-overhead weak clustering/grouping algorithm. As shown previously in FIG. 10, the cache budget into two parts: C_{IMPORTANT} and C_{REPRESENTATIVE}. The first part selects the top C_{IMPORTANT} tokens to keep (e.g., important tokens), and the remaining part is used to store C_{IMPORTANT} number of proxies/representatives for the tokens to be dropped (e.g., unimportant tokens or tokens to be pruned).

In some embodiments, a suitable technique can be implemented to determine C_{IMPORTANT} number of important tokens. One example of a suitable technique may include selecting these C_{IMPORTANT} tokens based on the normalized row sum of the attention weights (previously illustrated as 1202 of FIG. 12), keeping only the subset of tokens with the highest normalized row sums. In some embodiments, C_{IMPORTANT} tokens are selected based on attention weights of various tokens and comparing the attention weights against a threshold to classify whether a token is important or not. Herein, attention weights refer to values that indicate how relevant an input token is to the final output of the attention mechanism, how much an input token contributes to the attention output, or probabilities of how much each token should be focused on. The relevance or contribution can be measured in terms of attention weights corresponding to the token. An attention weight matrix can be calculated based on the query matrix and the key matrix. In some cases, a distance of the token to a current token being processed can be used to determine the attention weight of the token. In some cases, attention scores for various tokens may be calculated based on the attention weight matrix produced in an attention mechanism (e.g., an attention weight matrix produced based on the query matrix and the key matrix).

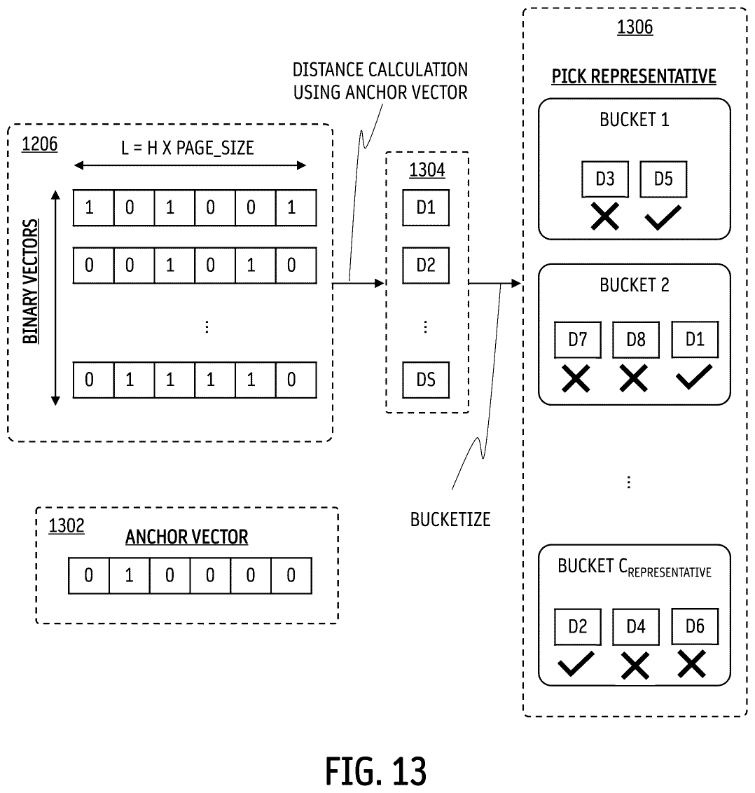

For the remaining unimportant tokens, KVCrush applies a weak clustering/grouping algorithm to represent them with a proxy or representative as illustrated in FIG. 13, which illustrates selecting representative tokens, according to some embodiments of the disclosure. Representative tokens selector 920 and/or token pruner 918 of FIG. 9 may implement the operations relating to selecting representatives and pruning non-representative tokens.

The input to the KVCrush process may include S binary vectors, depicted as 1206. One binary vector may be provided for each token. In cases where KVCrush is operating on a KV cache basis, the input may include P binary vectors or P binary feature vectors, where P is the number of KV cache pages.

The KVCrush process includes selecting one or more anchor vectors, or one or more anchor points. An exemplary anchor vector 1302 is depicted. The length of the anchor vector 1302 matches the length of the binary vectors. The one or more anchor vectors are used as one or more points (or constant, non-changing points) in a multi-dimensional feature space based on which distances of other points in the multi-dimensional feature space to the one or more points can be calculated, and the distances can be used a proxy or heuristic for grouping or bucketizing similar points together.

In one example, the values of the anchor vector are determined randomly (e.g., randomly choosing a one/1 or a zero/0 based on a binomial probability distribution for each value of the anchor vector). A random-based anchor vector may include a random vector of zeros and ones. In one example, the values of the anchor vector are determined based on a mean of values of the binary vectors. A mean-based anchor point may include a mean vector of the binary vectors. In one example, the values of the anchor vector are determined based on a median of values of the binary vectors. A median-based anchor point may include a median vector of the binary vectors. In one example, the values of the anchor vector have alternating zeros and ones. An alternating zeros and ones anchor vector may include an alternating sequence of ones and zeros, or zeros and ones. In one example, the values of the anchor vector have a pattern of zeros and ones.

The KVCrush process can use the one or more anchor vectors 1302 to perform a grouping or bucketizing process, which may include calculating the one or more distances of the one or more binary vectors representing the one or more tokens to the anchor vector. For a binary vector representing a token (e.g., a binary vector in binary vectors depicted as 1206), a distance can be calculated for the binary vector to the anchor vector. For S binary vectors, S distances can be calculated, one distance per each token, with respect to the anchor vector. For P binary vectors, P distances can be calculated, one distance per each KV cache page, with respect to the anchor vector. Calculated distances, such as S distances, are depicted as 1304.

If more than one anchor vector is used, a composite distance of the binary vector based on distances of the binary vector to the different anchor vectors can be calculated. For S binary vectors, S composite distances can be calculated, one composite distance per each token, with respect to the plurality of anchor vectors. For P binary vectors, P composite distances can be calculated, one composite distance per each KV cache page, with respect to the plurality of anchor vectors.

In some cases, the distance of a binary vector to an anchor vector is a Hamming distance. The Hamming distance is simple to calculate and measures the number of positions at which the binary vector and the anchor vector are different (or the same). The Hamming distance may count the number of bit flips to transform the binary vector to the anchor vector. The range of the Hamming dance is from 0 (identical vectors) to the length of the binary vector (which is the same as the length of the anchor vector).

In some cases, the distance of a binary vector to an anchor vector is a Jaccard distance. Jaccard distance can measure dissimilarity between the binary vector and the anchor vector by comparing their set-like properties. Jaccard distance can be calculated as 1−(intersection size/union size) of the binary vector and the anchor vector. Jaccard distance may be beneficial for treating the binary vector and the anchor vector as sets of binary features. The range of the Jaccard distance is from 0 (identical sets) to 1 (completely different sets).

In some cases, the distance of a binary vector to an anchor vector is a cosine distance. Cosine distance can measure the cosine of the angle between the binary vector and the anchor vector. To measure the cosine distance between the binary vector and the anchor vector, the overlap of “1” positions between the binary vector and the anchor vector is determined or measured. The range of the cosine distance is from 0 (identical vectors) to 1 (orthogonal/dissimilar vectors).

In some cases, the distance of a binary vector to an anchor vector is a matching distance. The matching distance can compute the proportion of matching positions between the binary vector and the anchor vector. The matching distance can count both matching zeros and ones and can be used when both zero and one are equally important for the distance. The range of the matching distance is from 0 (completely different) to 1 (identical).

In some cases, the distance of a binary vector to an anchor vector is a dice coefficient. Similar to the Jaccard distance, the dice coefficient may give more weight to shared one positions. The dice coefficient can be calculated as 2*(number of shared ones in the binary vector and the anchor vector)/(total ones in both the binary vector and the anchor vector). The range of the dice coefficient is from 0 (completely different) to 1 (identical).

In some cases, the composite distance of a binary vector to multiple anchor vectors is a Euclidean distance. The Euclidean distance may calculate a straight-line distance based on the distances of the binary vector to the anchor vectors. If the individual distances of the binary vector to the anchor vectors are e1, e2, and e3, the Euclidean distance would be the square root of the sum of the squared distances, or \sqrt{e1²+e2²+e3²}. In some embodiments, individual distances (e.g., Hamming distances) can be calculated for each anchor vector per binary vector. The Hamming distances can form a distance vector and the magnitude of the distance vector can be used as the composite distance for the binary vector.

In some cases, the composite distance of a binary vector to multiple anchor vectors is the Manhattan distance, which can measure distance like a grid. The Manhattan distance can be calculated as a sum of absolute distances. If the individual distances of the binary vector to the anchor vectors are e1, e2, and e3, the Manhattan distance would be the sum of the absolute distances, or |e1|+|e2|+|e3|.

In some cases, the composite distance of a binary vector to multiple anchor vectors is the Chebyshev distance, which measures a maximum of the distances. The If the individual distances of the binary vector to the anchor vectors are e1, e2, and e3, the Chebyshev distance would be the max of the absolute distances, or max (|e1|, |e2|, |e3|).

The grouping or bucketization process further includes setting up the buckets according to the cache budget. If the cache budget allocates storing C_{REPRESENTATIVE} tokens in the KV cache as representatives or proxies for the unimportant tokens, then C_{REPRESENTATIVE} buckets are setup, depicted as 1306. One or more ranges of distances corresponding to the one or more buckets can be determined. The range of distances can be divided up equally into C_{REPRESENTATIVE} evenly sized ranges of distances, and each bucket can be assigned to a C_{REPRESENTATIVE} range of distance in the ranges of distances. The range of distances can be divided up based on percentiles into C_{REPRESENTATIVE} ranges of distances, and each bucket can be assigned to a range of distance in the C_{REPRESENTATIVE} ranges of distances. Dividing up the range of distances based on percentiles can have the advantage of ensuring roughly the same number or some percentage of tokens will be assigned or bucketized to the various buckets. The ranges of distances determined for the various buckets may have the same sizes, but in some cases, the ranges may have different sizes.

The one or more tokens can be assigned to the one or more buckets according to the one or more ranges of distances and the one or more distances. The distances, depicted as 1304, can be placed into C_{REPRESENTATIVE} buckets, depicted as 1306. Placing a distance or a token into a bucket involves checking whether a distance is within a particular range of distances assigned for a given bucket. No sorting is required.

After bucketizing or grouping of tokens using the distances, a representative token can be picked or selected from each bucket. For example, a representative token can be selected at random or randomly. In some cases, the first token assigned to the bucket is selected to be the representative token. In some cases, the last token assigned to the bucket is selected to be the representative token. A selected representative token may have a checkmark in FIG. 13, and a non-selected representative token may have an X in FIG. 13. As a result, C_{REPRESENTATIVE} number of representative tokens are selected from the C_{REPRESENTATIVE} number of buckets. A selected representative token can be used as the representative or proxy for the representative token and for other token(s) assigned to a given bucket. The KV caches (calculated key tensors and value tensors) corresponding to the representative token are used as the representative/proxy key tensors and value tensors for all tokens assigned to the given bucket. The other tokens (e.g., the KV caches corresponding to the other tokens) are dropped or evicted. These C_{REPRESENTATIVE} representative tokens, along with the C_{IMPORTANT} tokens selected previously, are finally retained in the KV cache.

Using one or more anchor points in a one-shot bucketizing manner to find representatives/proxies allows KVCrush to perform pruning with just S (or P) distance comparisons instead of using O(S²) (or O(P²)) distance computations as carried out by clustering algorithms such as k-means clustering algorithms.

Selecting appropriate anchor vectors may impact accuracy of the representatives or proxies. In one implementation, KVCrush employs an anchor vector within the same binary space (a binary vector with a length equal to the number of heads) to form buckets of tokens based on their Hamming distance to this anchor vector. Using different types of anchor points may impact the accuracy of the buckets relative to the ideal clusters formed using k-means algorithm. Using more anchor points may improve the accuracy of the buckets with minimal additional overhead in calculating the final distances.

Notably, k-means clustering algorithms exhibit significant inefficiencies in KV cache compression due to two primary factors. Firstly, the large size of input vectors poses a challenge. For instance, in one transformer-based model having 8 billion parameters, each input key (or value) vector comprises 128 FP16 values. By employing the efficient representation of key-value states of KVCrush, a binary vector of length 32 (corresponding to the number of attention heads) can be generated to represent each token (key-value pair). This approach not only reduces the data size by a factor of 64 but also enables faster distance computations using Hamming distances. Secondly, the time complexity associated with clustering algorithms for data grouping is substantial. Utilizing the low-overhead pruning algorithm of KVCrush, the selection of values to be retained in the cache (the selection of the representatives/proxies) is achieved in linear time, in contrast to the quadratic time complexity of k-means clustering.

### Using KVCrush at the KV Cache Page Level

The techniques described herein for KVCrush can be performed at the KV cache page level rather than at the token level. At a page level, the KV cache page has a plurality of tokens. To evaluate KVCrush in KV cache paging implementations, a row-wise sum of attention weights at the page level (each page is represented as a row of attention weights) can be used to evict unimportant pages and identify important pages. In addition, the binary vector of a page (e.g., calculated using the operations illustrated in FIGS. 11-12 can be formed by concatenating in an interleaved manner using the binary vectors of all tokens within that page. Moreover, distances can be calculated for the binary vectors of the pages with respect to one or more anchor vectors. The distances can be used in bucketizing the pages into buckets. A number of buckets are setup based on the cache budget allocated for storing representative KV caches of pages. A representative page can be selected (e.g., at random) from a given bucket, and the KV caches computed for tokens of the representative page can be used as the representative or proxy for the KV caches of the pages assigned to the given bucket.

### Methods for KV Cache Management

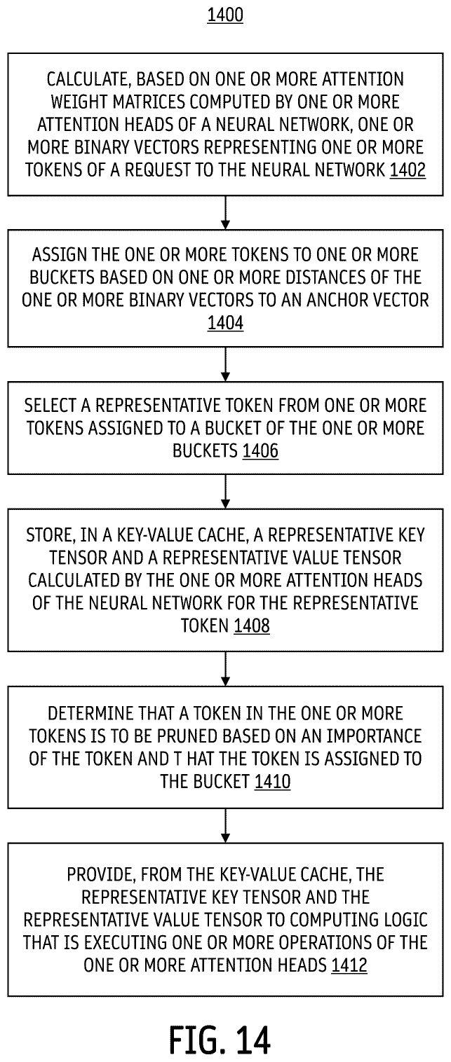

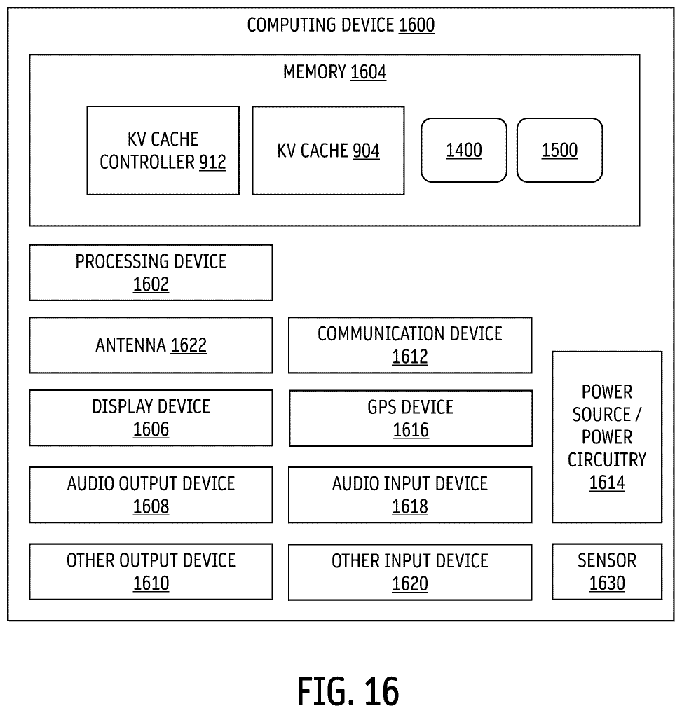

FIG. 14 is a flowchart illustrating a method for KV cache management, according to some embodiments of the disclosure. Method 1400 can be implemented by one or more components of KV cache controller 912 of FIG. 9. Method 1400 can be implemented to offer efficient token pruning. Method 1400 can be performed using a computing device, such as computing device 1600 in FIG. 16.

In 1402, based on one or more attention weight matrices computed by one or more attention heads of a neural network, one or more binary vectors are calculated. The one or more binary vectors can represent one or more tokens of a request to the neural network.

In 1404, the one or more tokens are assigned to one or more buckets based on one or more distances of the one or more binary vectors to an anchor vector.

In 1406, a representative token is selected from one or more tokens assigned to a bucket of the one or more buckets.

In 1408, a representative key tensor and a representative value tensor calculated by the one or more attention heads of the neural network for the representative token are stored in the key-value cache.

In 1410, a token in the one or more tokens is determined to be pruned based on an importance of the token. It is determined that the token is assigned to the bucket.

In 1412, the representative key tensor and the representative value tensor are provided from the key-value cache to computing logic that is executing one or more operations of the one or more attention heads.

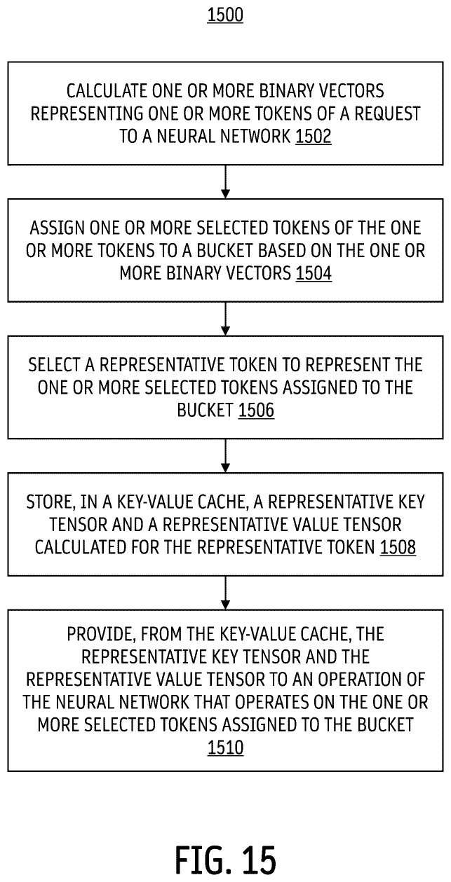

FIG. 15 is a flowchart illustrating a method for KV cache management, according to some embodiments of the disclosure. Method 1500 can be implemented by one or more components of KV cache controller 912 of FIG. 9. Method 1500 can be implemented to offer efficient token pruning. Method 1500 can be performed using a computing device, such as computing device 1600 in FIG. 16.

In 1502, one or more binary vectors representing one or more tokens of a request to a neural network can be calculated.

In 1504, one or more selected tokens of the one or more tokens can be assigned to a bucket based on the one or more binary vectors, e.g., one or more binary vectors representing the one or more selected tokens.

In 1506, a representative token can be selected to represent the one or more selected tokens assigned to the bucket.

In 1508, a representative key tensor and a representative value tensor calculated for the representative token can be stored in the key-value cache. The representative key tensor and the representative value tensor serve as a proxy or representative of key tensor(s) and value tensor(s) calculated for the one or more selected tokens assigned to the bucket. Key tensor(s) and value tensor(s) that are calculated for the non-representative token(s) are discarded or evicted. The representative key tensor and the representative value tensor calculated for the representative tensor are retained.

In 1510, the representative key tensor and the representative value tensor are provided to an operation of the neural network (e.g., an attention head) that operates on the one or more selected tokens assigned to the bucket.

### Exemplary Computing Device

FIG. 16 is a block diagram of an apparatus or a system, e.g., an exemplary computing device 1600, according to some embodiments of the disclosure. One or more computing devices 1600 may be used to implement the functionalities described with the FIGS. and herein. A number of components illustrated in FIG. 16 can be included in computing device 1600, but any one or more of these components may be omitted or duplicated, as suitable for the application. In some embodiments, some or all of the components included in computing device 1600 may be attached to one or more motherboards. In some embodiments, some or all of these components are fabricated onto a single system on a chip (SoC) die. Additionally, in various embodiments, computing device 1600 may not include one or more of the components illustrated in FIG. 16, and computing device 1600 may include interface circuitry for coupling to the one or more components. For example, the computing device 1600 may not include display device 1606, and may include display device interface circuitry (e.g., a connector and driver circuitry) to which a display device 1606 may be coupled. In another set of examples, computing device 1600 may not include audio input device 1618 or an audio output device 1608 and may include audio input or output device interface circuitry (e.g., connectors and supporting circuitry) to which an audio input device 1618 or audio output device 1608 may be coupled.

Computing device 1600 may include processing device 1602 (e.g., one or more processing devices, one or more of the same types of processing device, one or more of different types of processing device). Processing device 1602 may include electronic circuitry that process electronic data from data storage elements (e.g., registers, memory, resistors, capacitors, quantum bit cells) to transform that electronic data into other electronic data that may be stored in registers and/or memory. Examples of processing device 1602 may include a CPU, a GPU, a quantum processor, a machine learning processor, an artificial intelligence processor, a neural network processor, a neural processing unit (NPU), an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

The computing device 1600 may include a memory 1604, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1604 includes one or more non-transitory computer-readable storage media. In some embodiments, memory 1604 may include memory that shares a die with the processing device 1602.

In some embodiments, memory 1604 includes one or more non-transitory computer-readable media storing instructions executable to perform operations described with the FIGS. and herein, such as the methods and operations illustrated in the FIGS. In some embodiments, memory 1604 includes one or more non-transitory computer-readable media storing instructions executable to perform one or more operations illustrated in FIGS. 10-13. In some embodiments, memory 1604 includes one or more non-transitory computer-readable media storing instructions executable to perform operations of method 1400 of FIG. 14. Exemplary parts that may be encoded as instructions and stored in memory 1604 are depicted. Memory 1604 may store instructions that encode one or more exemplary parts, such as one or more components of KV cache controller 912. The instructions stored in the one or more non-transitory computer-readable media may be executed by processing device 1602.

In some embodiments, memory 1604 may store data, e.g., data structures, binary data, bits, metadata, files, blobs, etc., as described with the FIGS. and herein. For example, memory 1604 may include KV cache 904 and the KV cache 904 may store key tensors and value tensors. Memory 1604 may store representative key tensors and representative value tensors. Memory 1604 may store importance scores of tokens. Memory 1604 may store binary vectors representing tokens, or KV cache pages. Memory 1604 may store associations of tokens to buckets. Memory 1604 may store input data, intermediate data, and output data of the KVCrush algorithm.

In some embodiments, the computing device 1600 may include a communication device 1612 (e.g., one or more communication devices). For example, the communication device 1612 may be configured for managing wired and/or wireless communications for the transfer of data to and from the computing device 1600. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1612 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1612 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1612 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1612 may operate in accordance with other wireless protocols in other embodiments. The computing device 1600 may include an antenna 1622 to facilitate wireless communications and/or to receive other wireless communications (such as radio frequency transmissions). The computing device 1600 may include receiver circuits and/or transmitter circuits. In some embodiments, the communication device 1612 may manage wired communications, such as electrical, optical, or any other suitable communication protocols (e.g., the Ethernet). As noted above, the communication device 1612 may include multiple communication chips. For instance, a first communication device 1612 may be dedicated to shorter-range wireless communications such as Wi-Fi or Bluetooth, and a second communication device 1612 may be dedicated to longer-range wireless communications such as global positioning system (GPS), EDGE, GPRS, CDMA, WiMAX, LTE, EV-DO, or others. In some embodiments, a first communication device 1612 may be dedicated to wireless communications, and a second communication device 1612 may be dedicated to wired communications.

The computing device 1600 may include power source/power circuitry 1614. The power source/power circuitry 1614 may include one or more energy storage devices (e.g., batteries or capacitors) and/or circuitry for coupling components of the computing device 1600 to an energy source separate from the computing device 1600 (e.g., DC power, AC power, etc.).

The computing device 1600 may include a display device 1606 (or corresponding interface circuitry, as discussed above). The display device 1606 may include any visual indicators, such as a heads-up display, a computer monitor, a projector, a touchscreen display, a liquid crystal display (LCD), a light-emitting diode display, or a flat panel display, for example.

The computing device 1600 may include an audio output device 1608 (or corresponding interface circuitry, as discussed above). The audio output device 1608 may include any device that generates an audible indicator, such as speakers, headsets, or earbuds, for example.

The computing device 1600 may include an audio input device 1618 (or corresponding interface circuitry, as discussed above). The audio input device 1618 may include any device that generates a signal representative of a sound, such as microphones, microphone arrays, or digital instruments (e.g., instruments having a musical instrument digital interface (MIDI) output).

The computing device 1600 may include a GPS device 1616 (or corresponding interface circuitry, as discussed above). The GPS device 1616 may be in communication with a satellite-based system and may receive a location of the computing device 1600, as known in the art.

The computing device 1600 may include a sensor 1630 (or one or more sensors). The computing device 1600 may include corresponding interface circuitry, as discussed above). Sensor 1630 may sense physical phenomenon and translate the physical phenomenon into electrical signals that can be processed by, e.g., processing device 1602. Examples of sensor 1630 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1600 may include another output device 1610 (or corresponding interface circuitry, as discussed above). Examples of the other output device 1610 may include an audio codec, a video codec, a printer, a wired or wireless transmitter for providing information to other devices, haptic output device, gas output device, vibrational output device, lighting output device, home automation controller, or an additional storage device.

The computing device 1600 may include another input device 1620 (or corresponding interface circuitry, as discussed above). Examples of the other input device 1620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1600 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1600 may be any other electronic device that processes data.

### Select Examples

Example 1 provides an apparatus including machine-readable instructions; one or more memories storing a key-value cache; and at least one computer processor, when executing the machine-readable instructions, is to: calculate one or more binary vectors representing one or more tokens of a request to a neural network; assign one or more selected tokens of the one or more tokens to a bucket based on the one or more binary vectors; select a representative token to represent the one or more selected tokens assigned to the bucket; store, in the key-value cache, a representative key tensor and a representative value tensor calculated for the representative token; and provide, from the key-value cache, the representative key tensor and the representative value tensor to an operation of the neural network that operates on the one or more selected tokens assigned to the bucket.

Example 2 provides the apparatus of example 1, where calculating the one or more binary vectors includes calculating the one or more binary vectors based on one or more attention weight matrices computed by one or more attention heads of the neural network.

Example 3 provides the apparatus of example 1 or 2, where calculating the one or more binary vectors include calculating a normalized row sum of an attention weight matrix calculated by the neural network; and binarizing the normalized row sum using a threshold.

Example 4 provides the apparatus of any one of examples 1-3, where a binary vector of the one or more binary vectors includes a binary value for each attention head of one or more attention heads of the neural network.

Example 5 provides the apparatus of example 4, where the binary value is a selection bit indicating whether a given attention head of attention heads of the neural network attends to a particular token or disregards the particular token.

Example 6 provides the apparatus of any one of examples 1-5, where assigning the one or more selected tokens to the bucket includes calculating one or more distances of the one or more binary vectors representing the one or more tokens to an anchor vector; determining a range of distances corresponding to the bucket; and assigning the one or more selected tokens to the bucket according to the range of distances and the one or more distances.

Example 7 provides the apparatus of any one of examples 1-6, where assigning the one or more selected tokens to the bucket includes determining one or more values of an anchor vector randomly; and assigning the one or more selected tokens to the bucket based on one or more distances of the one or more binary vectors to the anchor vector.

Example 8 provides the apparatus of any one of examples 1-6, where assigning the one or more selected tokens to the bucket includes determining one or more values of an anchor vector based on a mean of the one or more binary vectors; and assigning the one or more selected tokens to the bucket based on one or more distances of the one or more binary vectors to the anchor vector.

Example 9 provides the apparatus of any one of examples 1-6, where assigning the one or more selected tokens to the bucket includes assigning the one or more selected tokens to the bucket based on one or more distances of the one or more binary vectors to an anchor vector, the anchor vector having alternating zeros and ones.

Example 10 provides the apparatus of any one of examples 6-9, where the one or more distances include one or more Hamming distances.

Example 11 provides the apparatus of any one of examples 1-10, where selecting the representative token from the one or more selected tokens assigned to the bucket includes selecting the representative token from the one or more selected tokens randomly.

Example 12 provides the apparatus of any one of examples 1-11, where: the representative key tensor and the representative value tensor are calculated by an attention head of the neural network for the representative token; and the representative key tensor and the representative value tensor represent one or more key tensors and one or more value tensors calculated by the attention head of the neural network for the one or more selected tokens.

Example 13 provides the apparatus of any one of examples 1-12, where the at least one computer processor is further to: assign one or more further selected tokens of the one or more tokens to a further bucket based on the one or more binary vectors; select a further representative token to represent one or more further selected tokens assigned to the further bucket; store, in the key-value cache, a further representative key tensor and a further representative value tensor calculated for the further representative token; determine that a further token of the request is one of the one or more further selected tokens assigned to the further bucket; and provide, from the key-value cache, the further representative key tensor and the further representative value tensor to be used in the operation of the neural network that operates on the further token.

Example 14 provides the apparatus of any one of examples 1-13, where the at least one computer processor is further to: determine that the one or more selected tokens are to be pruned based on one or more importance values of the one or more selected tokens.

Example 15 provides the apparatus of any one of examples 1-13, where the at least one computer processor is further to: evict, from the key-value cache, one or more key tensors and one or more value tensors calculated for one or more remaining tokens assigned to the bucket that are not selected as the representative token.

Example 16 provides one or more non-transitory computer-readable media storing instructions executable by a processor to perform operations for managing a key-value cache, the operations including calculating one or more binary vectors representing one or more tokens of a request to a neural network; assigning one or more selected tokens of the one or more tokens to a bucket based on the one or more binary vectors; selecting a representative token to represent the one or more selected tokens assigned to the bucket; storing, in the key-value cache, a representative key tensor and a representative value tensor calculated for the representative token; and providing, from the key-value cache, the representative key tensor and the representative value tensor to an operation of the neural network that operates on the one or more selected tokens assigned to the bucket.

Example 17 provides the one or more non-transitory computer-readable media of example 16, where calculating the one or more binary vectors includes calculating the one or more binary vectors based on one or more attention weight matrices computed by one or more attention heads of the neural network.

Example 18 provides the one or more non-transitory computer-readable media of example 16 or 17, where calculating the one or more binary vectors include calculating a normalized row sum of an attention weight matrix calculated by the neural network; and binarizing the normalized row sum using a threshold.

Example 19 provides the one or more non-transitory computer-readable media of any one of examples 16-18, where a binary vector of the one or more binary vectors includes a binary value for each attention head of one or more attention heads of the neural network.

Example 20 provides the one or more non-transitory computer-readable media of example 19, where the binary value is a selection bit indicating whether a given attention head of attention heads of the neural network attends to a particular token or disregards the particular token.

Example 21 provides the one or more non-transitory computer-readable media of any one of examples 16-20, where assigning the one or more selected tokens to the bucket includes calculating one or more distances of the one or more binary vectors representing the one or more tokens to an anchor vector; determining a range of distances corresponding to the bucket; and assigning the one or more selected tokens to the bucket according to the range of distances and the one or more distances.

Example 22 provides the one or more non-transitory computer-readable media of any one of examples 16-21, where assigning the one or more selected tokens to the bucket includes determining one or more values of an anchor vector randomly; and assigning the one or more selected tokens to the bucket based on one or more distances of the one or more binary vectors to the anchor vector.

Example 23 provides the one or more non-transitory computer-readable media of any one of examples 16-21, where assigning the one or more selected tokens to the bucket includes determining one or more values of an anchor vector based on a mean of the one or more binary vectors; and assigning the one or more selected tokens to the bucket based on one or more distances of the one or more binary vectors to the anchor vector.

Example 24 provides the one or more non-transitory computer-readable media of any one of examples 16-21, where assigning the one or more selected tokens to the bucket includes assigning the one or more selected tokens to the bucket based on one or more distances of the one or more binary vectors to an anchor vector, the anchor vector having alternating zeros and ones.

Example 25 provides the one or more non-transitory computer-readable media of any one of examples 21-24, where the one or more distances include one or more Hamming distances.

Example 26 provides the one or more non-transitory computer-readable media of any one of examples 16-25, where selecting the representative token from the one or more selected tokens assigned to the bucket includes selecting the representative token from the one or more selected tokens randomly.

Example 27 provides the one or more non-transitory computer-readable media of any one of examples 16-26, where: the representative key tensor and the representative value tensor are calculated by an attention head of the neural network for the representative token; and the representative key tensor and the representative value tensor represent one or more key tensors and one or more value tensors calculated by the attention head of the neural network for the one or more selected tokens.

Example 28 provides the one or more non-transitory computer-readable media of any one of examples 16-27, where the processor is further to: assign one or more further selected tokens of the one or more tokens to a further bucket based on the one or more binary vectors; select a further representative token to represent one or more further selected tokens assigned to the further bucket; store, in the key-value cache, a further representative key tensor and a further representative value tensor calculated for the further representative token; determine that a further token of the request is one of the one or more further selected tokens assigned to the further bucket; and provide, from the key-value cache, the further representative key tensor and the further representative value tensor to be used in the operation of the neural network that operates on the further token.

Example 29 provides the one or more non-transitory computer-readable media of any one of examples 16-28, where the processor is further to: determine that the one or more selected tokens are to be pruned based on one or more importance values of the one or more selected tokens.

Example 30 provides the one or more non-transitory computer-readable media of any one of examples 16-29, where the processor is further to: evict, from the key-value cache, one or more key tensors and one or more value tensors calculated for one or more remaining tokens assigned to the bucket that are not selected as the representative token.

Example 31 provides a method for managing a key-value cache, including calculating one or more binary vectors representing one or more tokens of a request to a neural network; assigning one or more selected tokens of the one or more tokens to a bucket based on the one or more binary vectors; selecting a representative token to represent the one or more selected tokens assigned to the bucket; storing, in the key-value cache, a representative key tensor and a representative value tensor calculated for the representative token; and providing, from the key-value cache, the representative key tensor and the representative value tensor to an operation of the neural network that operates on the one or more selected tokens assigned to the bucket.

Example 32 provides the method of example 31, where calculating the one or more binary vectors includes calculating the one or more binary vectors based on one or more attention weight matrices computed by one or more attention heads of the neural network.

Example 33 provides the method of example 31 or 32, where calculating the one or more binary vectors include calculating a normalized row sum of an attention weight matrix calculated by the neural network; and binarizing the normalized row sum using a threshold.

Example 34 provides the method of any one of examples 31-33, where a binary vector of the one or more binary vectors includes a binary value for each attention head of one or more attention heads of the neural network.

Example 35 provides the method of example 34, where the binary value is a selection bit indicating whether a given attention head of attention heads of the neural network attends to a particular token or disregards the particular token.

Example 36 provides the method of any one of examples 31-35, where assigning the one or more selected tokens to the bucket includes calculating one or more distances of the one or more binary vectors representing the one or more tokens to an anchor vector; determining a range of distances corresponding to the bucket; and assigning the one or more selected tokens to the bucket according to the range of distances and the one or more distances.

Example 37 provides the method of any one of examples 31-36, where assigning the one or more selected tokens to the bucket includes determining one or more values of an anchor vector randomly; and assigning the one or more selected tokens to the bucket based on one or more distances of the one or more binary vectors to the anchor vector.

Example 38 provides the method of any one of examples 31-36, where assigning the one or more selected tokens to the bucket includes determining one or more values of an anchor vector based on a mean of the one or more binary vectors; and assigning the one or more selected tokens to the bucket based on one or more distances of the one or more binary vectors to the anchor vector.

Example 39 provides the method of any one of examples 31-36, where assigning the one or more selected tokens to the bucket includes assigning the one or more selected tokens to the bucket based on one or more distances of the one or more binary vectors to an anchor vector, the anchor vector having alternating zeros and ones.

Example 40 provides the method of any one of examples 36-39, where the one or more distances include one or more Hamming distances.

Example 41 provides the method of any one of examples 31-40, where selecting the representative token from the one or more selected tokens assigned to the bucket includes selecting the representative token from the one or more selected tokens randomly.

Example 42 provides the method of any one of examples 31-41, where: the representative key tensor and the representative value tensor are calculated by an attention head of the neural network for the representative token; and the representative key tensor and the representative value tensor represent one or more key tensors and one or more value tensors calculated by the attention head of the neural network for the one or more selected tokens.

Example 43 provides the method of any one of examples 31-42, further including assigning one or more further selected tokens of the one or more tokens to a further bucket based on the one or more binary vectors; selecting a further representative token to represent one or more further selected tokens assigned to the further bucket; storing, in the key-value cache, a further representative key tensor and a further representative value tensor calculated for the further representative token; determining that a further token of the request is one of the one or more further selected tokens assigned to the further bucket; and providing, from the key-value cache, the further representative key tensor and the further representative value tensor to be used in the operation of the neural network that operates on the further token.

Example 44 provides the method of any one of examples 31-43, further including determining that the one or more selected tokens are to be pruned based on one or more importance values of the one or more selected tokens.

Example 45 provides the method of any one of examples 31-44, further including evicting, from the key-value cache, one or more key tensors and one or more value tensors calculated for one or more remaining tokens assigned to the bucket that are not selected as the representative token.

Example A includes an apparatus comprising means to perform any one of the methods in examples 31-45.

Example B includes a KV cache controller as described herein.

Example C includes a computing system having a compute core, a KV cache, and a KV cache controller as described herein (such as in FIG. 9).

### Variations and Other Notes

Although the operations of the example method shown in and described with reference to FIGS. are illustrated as occurring once each and in a particular order, it will be recognized that the operations may be performed in any suitable order and repeated as desired. Additionally, one or more operations may be performed in parallel. Furthermore, the operations illustrated in FIGS. may be combined or may include more or fewer details than described.

The various implementations described herein may refer to artificial intelligence, machine learning, and deep learning. Deep learning may be a subset of machine learning. Machine learning may be a subset of artificial intelligence. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus comprising:
machine-readable instructions;
one or more memories storing a key-value cache; and
at least one computer processor, when executing the machine-readable instructions, is to:
calculate one or more binary vectors representing one or more tokens of a request to a neural network;
assign one or more selected tokens of the one or more tokens to a bucket based on the one or more binary vectors;
select a representative token to represent the one or more selected tokens assigned to the bucket;
store, in the key-value cache, a representative key tensor and a representative value tensor calculated for the representative token; and
provide, from the key-value cache, the representative key tensor and the representative value tensor to an operation of the neural network that operates on the one or more selected tokens assigned to the bucket.

2. The apparatus of claim 1, wherein calculating the one or more binary vectors comprises calculating the one or more binary vectors based on one or more attention weight matrices computed by one or more attention heads of the neural network.

3. The apparatus of claim 1, wherein calculating the one or more binary vectors comprise:
calculating a normalized row sum of an attention weight matrix calculated by the neural network; and
binarizing the normalized row sum using a threshold.

4. The apparatus of claim 1, wherein a binary vector of the one or more binary vectors comprises a binary value for each attention head of one or more attention heads of the neural network.

5. The apparatus of claim 4, wherein the binary value is a selection bit indicating whether a given attention head of attention heads of the neural network attends to a particular token or disregards the particular token.

6. The apparatus of claim 1, wherein assigning the one or more selected tokens to the bucket comprises:
calculating one or more distances of the one or more binary vectors representing the one or more tokens to an anchor vector;
determining a range of distances corresponding to the bucket; and
assigning the one or more selected tokens to the bucket according to the range of distances and the one or more distances.

7. The apparatus of claim 1, wherein assigning the one or more selected tokens to the bucket comprises:
determining one or more values of an anchor vector randomly; and
assigning the one or more selected tokens to the bucket based on one or more distances of the one or more binary vectors to the anchor vector.

8. The apparatus of claim 1, wherein assigning the one or more selected tokens to the bucket comprises:
determining one or more values of an anchor vector based on a mean of the one or more binary vectors; and
assigning the one or more selected tokens to the bucket based on one or more distances of the one or more binary vectors to the anchor vector.

9. The apparatus of claim 1, wherein assigning the one or more selected tokens to the bucket comprises:
assigning the one or more selected tokens to the bucket based on one or more distances of the one or more binary vectors to an anchor vector, the anchor vector having alternating zeros and ones.

10. The apparatus of claim 6, wherein the one or more distances include one or more Hamming distances.

11. The apparatus of claim 1, wherein selecting the representative token from the one or more selected tokens assigned to the bucket comprises:
selecting the representative token from the one or more selected tokens randomly.

12. The apparatus of claim 1, wherein:
the representative key tensor and the representative value tensor are calculated by an attention head of the neural network for the representative token; and
the representative key tensor and the representative value tensor represent one or more key tensors and one or more value tensors calculated by the attention head of the neural network for the one or more selected tokens.

13. The apparatus of claim 1, wherein the at least one computer processor is further to:
assign one or more further selected tokens of the one or more tokens to a further bucket based on the one or more binary vectors;
select a further representative token to represent one or more further selected tokens assigned to the further bucket;
store, in the key-value cache, a further representative key tensor and a further representative value tensor calculated for the further representative token;
determine that a further token of the request is one of the one or more further selected tokens assigned to the further bucket; and
provide, from the key-value cache, the further representative key tensor and the further representative value tensor to be used in the operation of the neural network that operates on the further token.

14. The apparatus of claim 1, wherein the at least one computer processor is further to:
determine that the one or more selected tokens are to be pruned based on one or more importance values of the one or more selected tokens.

15. The apparatus of claim 1, wherein the at least one computer processor is further to:
evict, from the key-value cache, one or more key tensors and one or more value tensors calculated for one or more remaining tokens assigned to the bucket that are not selected as the representative token.

16. One or more non-transitory computer-readable media storing instructions executable by a processor to perform operations for managing a key-value cache, the operations comprising:
calculating one or more binary vectors representing one or more tokens of a request to a neural network;
assigning one or more selected tokens of the one or more tokens to a bucket based on the one or more binary vectors;
selecting a representative token to represent the one or more selected tokens assigned to the bucket;
storing, in the key-value cache, a representative key tensor and a representative value tensor calculated for the representative token; and
providing, from the key-value cache, the representative key tensor and the representative value tensor to an operation of the neural network that operates on the one or more selected tokens assigned to the bucket.

17. The one or more non-transitory computer-readable media of claim 16, wherein calculating the one or more binary vectors comprises calculating the one or more binary vectors based on one or more attention weight matrices computed by one or more attention heads of the neural network.

18. The one or more non-transitory computer-readable media of claim 16, wherein calculating the one or more binary vectors comprise:
calculating a normalized row sum of an attention weight matrix calculated by the neural network; and
binarizing the normalized row sum using a threshold.

19. A method for managing a key-value cache, comprising:
calculating one or more binary vectors representing one or more tokens of a request to a neural network;
assigning one or more selected tokens of the one or more tokens to a bucket based on the one or more binary vectors;
selecting a representative token to represent the one or more selected tokens assigned to the bucket;
storing, in the key-value cache, a representative key tensor and a representative value tensor calculated for the representative token; and
providing, from the key-value cache, the representative key tensor and the representative value tensor to an operation of the neural network that operates on the one or more selected tokens assigned to the bucket.

20. The method of claim 19, wherein assigning the one or more selected tokens to the bucket comprises:
calculating one or more distances of the one or more binary vectors representing the one or more tokens to an anchor vector;
determining a range of distances corresponding to the bucket; and
assigning the one or more selected tokens to the bucket according to the range of distances and the one or more distances.
